(19) United States
(12) Patent Application Publication
(10) Pub. No.: US 2017/0283316 A1
(43) Pub. Date: Oct. 5, 2017

(54) REPELLENT COATINGS COMPRISING SINTERED PARTICLES AND LUBRICANT, ARTICLES & METHOD

(71) Applicant: 3M INNOVATIVE PROPERTIES COMPANY, St. Paul, MN (US)

(72) Inventors: Adam J. Meuler, Woodbury, MN (US); Nicholas L. Untiedt, Minneapolis, MN (US); Stephen C.P. Joseph, Woodbury, MN (US); Thomas P. Klun, Lakeland, MN (US); Naiyong Jing, St. Paul, MN (US); Paul B. Armstrong, St. Paul, MN (US)

(21) Appl. No.: 15/511,390

(22) PCT Filed: Oct. 9, 2015
(86) PCT No.: PCT/US2015/054820

§ 371 Date: Mar. 15, 2017

Related U.S. Application Data
(60) Provisional application No. 62/069,507, filed on Oct. 28, 2014.

(51) Int. Cl. C03C 17/42; B05D 5/08

(52) U.S. Cl. CPC C03C 17/42; B05D 5/08; C03C 2217/425; C03C 2217/76

(57) ABSTRACT

Method of making an article are described comprising providing a substrate and forming a surface treated porous layer on a surface of the substrate. The porous layer comprises sintered inorganic oxide particles. A surface of the porous layer comprises a hydrophobic layer. The method further comprises impregnating a lubricant into pores of the surface treated porous layer. Also described are articles, comprising (a) a substrate; (b) a surface treated porous layer disposed on a surface of the substrate, wherein the surface treated porous layer comprises a plurality of sintered inorganic oxide particles arranged to form a porous three-dimensional network, and a hydrophobic layer disposed on a surface of the porous three-dimensional network, and (c) a lubricant impregnated in pores of the surface treated porous layer.

### BACKGROUND

Various synthetic repellent surfaces based on lubricant-impregnated textured surfaces have been described in the literature. This approach is inspired by the Nepenthes pitcher plant, having a microstructured peristome that is completely wet by secreted nectar and/or rainwater. The liquid forms a homogeneous film that covers the microstructured texture, and insects that come into contact with this liquid surface aquaplane down the peristome to be captured and subsequently digested by the plant.

Numerous strategies for imparting topographical texture that is suitable for subsequent lubricant impregnation have been described.

### SUMMARY

In one embodiment, a method of making an article is described comprising providing a substrate and forming a surface treated porous layer on a surface of the substrate. The porous layer comprises sintered inorganic oxide particles. A surface of the porous layer comprises a hydrophobic layer. The method further comprises impregnating a lubricant into pores of the surface treated porous layer.

In typical embodiments, the method of forming the surface treated porous layer comprises coating a plurality of inorganic oxide particles dispersed in a liquid medium on a surface of the substrate; sintering the inorganic oxide particles forming a porous layer; and coating a surface of the porous layer with a hydrophobic material.

The inorganic oxide particles may comprise nanoparticles (as defined herein), larger particles, or combinations thereof.

Also described are articles, comprising (a) a substrate; (b) a surface treated porous layer disposed on a surface of the substrate, wherein the surface treated porous layer comprises a plurality of sintered inorganic oxide particles arranged to form a porous three-dimensional network, and a hydrophobic layer disposed on a surface of the porous three-dimensional network, and (c) a lubricant impregnated in pores of the surface treated porous layer.

Sintered inorganic particles, such as silica, are mechanically durable. Additionally, such coatings can be applied to both organic and inorganic substrates. The particles are typically deposited from an aqueous dispersion and subsequently sintered by the application of heat that drives the condensation of silanol (Si—OH) moieties on nanosilica surfaces into Si—O—Si bonds.

In some favored embodiments, the particles are acid-sintered or base-sintered which is amenable to coating heat sensitive substrates such as thermoplastics. Acid-sintering typically does not necessitate the use of surfactants. The inorganic oxide particles are typically fixed to the substrate in the absence of an organic polymeric binder. Organic components, such as polymeric binder, can make it difficult to modify the surface chemistry of the porous layer for the desired lubricant.

### BRIEF DESCRIPTION OF THE DRAWINGS

FIG. 1A is a transmission electron micrograph of a surface of a comparative example porous layer formed without sintering of the silica nanoparticles.

FIG. 1B is a transmission electron micrograph of an exemplary surface of a porous layer comprising sintered silica nanoparticles.

FIG. 2 is a cross-sectional view of an article comprising a repellant coating.

### DETAILED DESCRIPTION

With reference to FIG. 2, presently described is an article 100 that comprises a substrate 110, a surface treated porous layer 120 disposed on a surface of the substrate, and a lubricant 150 disposed in pores 125 of the surface treated porous layer. The surface treated porous layer (120 with 128) is positioned between the substrate 110 and the impregnated lubricant 150. The surface treated porous layer comprises a plurality of sintered inorganic oxide (e.g. silica) particles 125 arranged to form a porous three-dimensional network. The surface treated porous layer comprises a hydrophobic layer 128 disposed on the porous three-dimensional network. The hydrophobic layer is generally disposed on the opposing surface of the porous layer relative to the surface of the porous layer disposed on (e.g. in contact with) the substrate. Thus, the porous layer can be considered to have two major surfaces, one major surface disposed on the substrate, and the opposing major surface comprising the hydrophobic coating impregnated with lubricant

The porous layer includes a porous network of sintered inorganic oxide particles. In typical embodiments, the inorganic oxides particles comprise or consist of silica. However, various other inorganic oxide particles can be used in place of silica or in combination with silica, such as alumina, titania, etc.

The term “nanoparticle” refers to particles that are submicron in size. In some embodiments, the nanoparticles have an average particle size, which typically refers to the average longest dimension of the particles, that is no greater than 500 nanometers, no greater than 200 nanometers, no greater than 100 nanometers, no greater than 75 nanometers, no greater than 50 nanometers, no greater than 40 nanometers, no greater than 25 nanometers, no greater than 20 nanometers, no greater than 10 nanometers, or no greater than 5 nanometers.

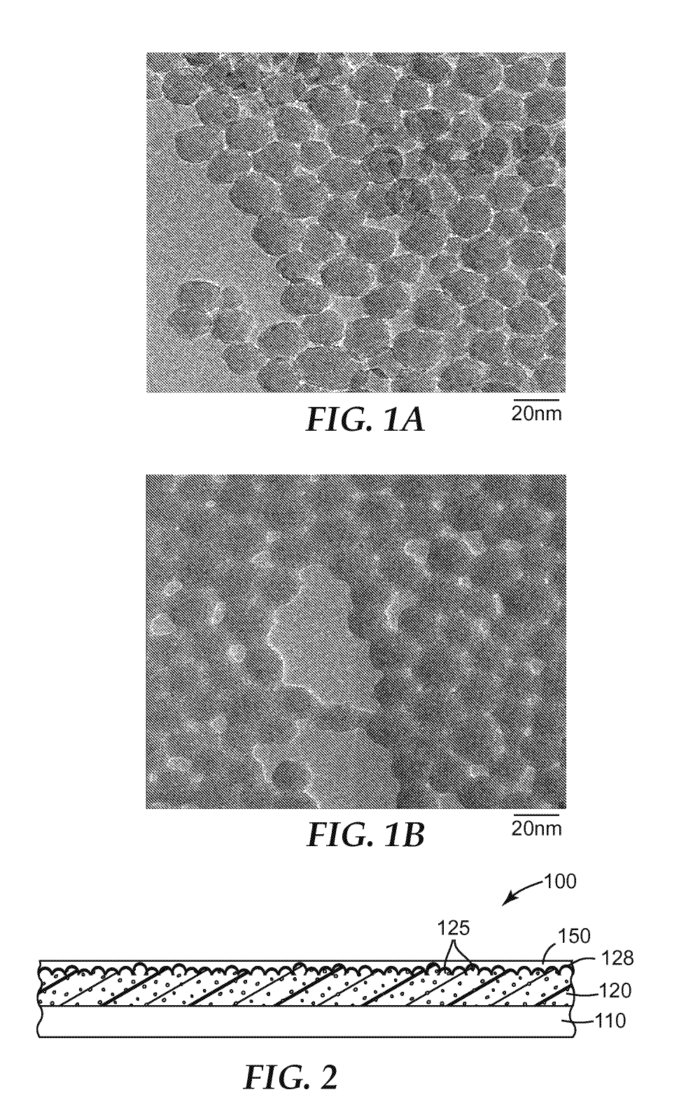

The average particle size is often determined using transmission electron microscopy but various light scattering methods can be used as well. The average particle size refers to the average particle size of the nanoparticles used to form the porous layer coating. That is, the average particle size refers to the average particle size of the inorganic oxide nanoparticles prior to sintering, such as depicted in FIG. 1A.

In some embodiments, the porous layer comprises thermally sintered inorganic oxide nanoparticles, such as fumed silica. Fumed silica is advantageously lower in cost in comparison to smaller non-aggregated nanoparticles. Fumed silica is commercially available from various suppliers including Evonik, under the trade designation “Aerosil”; Cabot under the trade designation “Cab-O-Sil”, and Wacker Chemie-Dow Corning. Fumed silica consists of microscopic droplets of amorphous silica fused into branched, chainlike, three-dimensional secondary aggregate particle. Thus, the fumed silica aggregates comprise sub-particles that are often referred to as primary particles, typically ranging in size from about 5 to 50 nm. Further, the aggregates can agglomerate. Thus, the particle size of the aggregates and agglomerates is considerably larger. For example, the average particle size (of aggregates and agglomerates) is typically greater than 10 microns (without sonication). Further, the average aggregate particle size after 90 seconds of sonication is typically ranges from 0.3 to 0.4 microns. The energy of mixing the fumed silica into a liquid medium is generally less than 90 seconds of sonication. Hence, the particle size of fumed silica in the liquid medium and dried coating thereof is surmised to range between the aggregate particle size (e.g. 0.3 to 0.4 microns) and the particle size without sonication (10 microns).

In certain embodiments, bimodal distributions of particle sizes may be used. For example, nanoparticles or particles having an average particle size of at least 150 or 200 nanometers can be used in combination with nanoparticles having an average (non-aggregate) particle size of no greater than 100, 80, 50 40, 30, 20, or 10 nanometers. The smaller sized sintered nanoparticles can be considered “mortar” for the larger particle size “bricks”. The weight ratio of the larger to smaller nanoparticles can be in the range of 2:98 to 98:2, in the range of 5:95 to 95:5, in the range of 10:90 to 90:10, or in the range of 20:80 to 80:20. In this embodiment, the larger sized particles may be fumed silica. The particle size of the larger inorganic oxide particles is typically no greater than 30, 25, 20 or 15 microns. In some embodiments, the porous layer is free of particles having a particle size greater than 10 microns.

The inclusion of larger particles can increase porosity and lower cost. However, the use of larger particles detracts from providing thin, uniform porous layers. Additionally, larger particles may result in the porous layer and repellant coating having a hazy appearance.

In some embodiments, the (e.g. silica) nanoparticles preferably have an average particle size (i.e., longest dimension) that is no greater than 100, 80, 50, 40, 30, 20 or 10 nanometers. In this embodiment, the porous layer may be free of particles having an average particle size greater than 100, 200, 300, 400, or 500 nanometers, such as fumed silica.

The (e.g. silica) inorganic oxide particles used to prepare the porous layer coating compositions can have any desired shape or mixture of shapes. The (e.g. silica) particles can be spherical or non-spherical (i.e., acicular) with any desired aspect ratio. Aspect ratio refers to the ratio of the average longest dimension of the particles to the average shortest dimension of acicular particles. The aspect ratio of acicular (e.g. silica) particles is often at least 2:1, at least 3:1, at least 5:1, or at least 10:1. Some acicular particles are in the shape of rods, ellipsoids, needles, and the like. The shape of the particles can be regular or irregular. The porosity of the coatings can be varied by changing the amount of regular and irregular shaped particles in the composition and/or by changing the amount of spherical and acicular particles in the composition.

For embodiments wherein the (e.g. silica) nanoparticles are spherical, the average diameter is often less than 50 nanometers, less than 40 nanometers, less than 25 nanometers, or less than 20 nanometers. Some nanoparticles can have an even smaller average diameter such as less than 10 nanometers or less than 5 nanometers.

For embodiments wherein the (e.g. silica) nanoparticles are acicular, they often have an average width (smallest dimension) equal to at least 1 nanometer, at least 2 nanometers, or at least 5 nanometers. The average width of acicular (e.g. silica) nanoparticles is often no greater than 25 nanometers, no greater than 20 nanometers, or no greater than 10 nanometers. The acicular nanoparticles can have an average length D₁ measured by dynamic light scattering methods that is, for example, at least 40 nanometers, at least 50 nanometers, at least 75 nanometers, or at least 100 nanometers. The average length D₁ (e.g., longer dimension) can be up to 200 nanometers, up to 400 nanometers, or up to 500 nanometers. The acicular nanoparticles may have degree of elongation D₁/D₂ in a range of 5 to 30, wherein D₂ means a diameter in nanometers calculated by the equation D₂=2720/S and S means specific surface area in meters squared per gram (m²/gram) of the nanoparticle, as described in U.S. Pat. No. 5,221,497 (Watanabe et al.).

In some embodiments, the particles (e.g. nanoparticles) typically have an average specific surface area equal to at least 150 m²/gram, at least 200 m²/gram, at least 250 m²/gram, at least 300 m²/gram, or at least 400 m²/gram. In other embodiments, the particles (e.g. nanoparticles) typically have an average specific surface area equal to at least 500 m²/gram, at least 600 m²/gram, or at least 700 m²/gram.

The (e.g. silica) inorganic oxide nanoparticles are typically commercially available in the form of a sol. Some examples of aqueous-based silica sols comprising spherical silica nanoparticles are commercially available under the trade designation LUDOX (e.g., LUDOX SM) from E.I. DuPont de Nemours and Co., Inc. (Wilmington, Del.). Other aqueous-based silica sols are commercially available under the trade designation NYACOL from Nyacol Co. (Ashland, Mass.). Still other aqueous-based silica sols are commercially available under the trade designation NALCO (e.g., NALCO 1115, NALCO 2326, and NALCO 1130) from Ondea Nalco Chemical Co. (Oak Brook, Ill.). Yet other aqueous-based silica sols are commercially available under the trade designation REMASOL (e.g., REMASOL SP30) from Remet Corporation (Utica, N.Y.) and under the trade designation SILCO (e.g., SILCO LI-518) from Silco International Inc (Portland, Oreg.).

Suitable non-spherical (i.e., acicular) inorganic oxide nanoparticles may also be obtained in the form of aqueous-based sol. Some acircular silica nanoparticles sols are available under the trade designation SNOWTEX from Nissan Chemical Industries (Tokyo, Japan). For example, SNOWTEX-UP contains silica nanoparticles having a diameter in the range of about 9 to 15 nanometers with lengths in a range of 40 to 300 nanometers. SNOWTEX-PS-S and SNOWTEX-PS-M have a chain of beads morphology. The SNOWTEX-PS-M particles are about 18 to 25 nanometers in diameter and have lengths of 80 to 150 nanometers. The SNOWTEX-PS-S has a particle diameter of 10-15 nm and a length of 80-120 nm.

The particles in the porous layer are sintered. At least some adjacent inorganic oxide particles tend to have bonds such as inorganic oxide (e.g. silica) “necks” joining them together. Stated differently, at least some adjacent particles tend to be joined (i.e. fused) together forming a three-dimensional porous network. FIG. 1B is a transmission electron micrograph of one example of a porous layer comprising sintered nanopartilces. Since sintering is utilized to bond the particles to each other, the porous layer of the sintered particles typically does not include an organic (e.g. polymeric) binder for the purpose of fixing the particles to the substrate. Thus, the inorganic oxide content of the sintered porous layer is typically at least 90, 95, 96, 97, 98, 99 or 100 wt-%.

The term “network” refers to a continuous three-dimensional structure formed by linking together inorganic oxide (e.g. silica) particles. The term “continuous” means that the individual particles are linked over a sufficient dimension (e.g. area) such that the porous layer, together with the hydrophobic layer and impregnated lubricant can provide the desired repellency of water or other liquid. In typical embodiments, the porous layer has no gaps or discontinuities in the areas where the sintered porous layer is present on the substrate. However, some discontinuities or gaps may be present provided that the presence thereof does not detract from the desired repellency properties.

The term “porous” refers to the presence of voids between the individual (e.g. silica) particles within the (e.g. continuous) porous layer coating. The network of (dried) sintered particles has a porosity of 20 to 50 volume percent, 25 to 45 volume percent, or 30 to 40 volume percent. Porosity may be calculated from the refractive index of the porous layer coating according to published procedures such as in W. L. Bragg and A. B. Pippard, Acta Crystallographica, 6, 865 (1953). Porosity tends to correlate to the roughness of the surface. In some embodiments, the porosity may be greater than 50 volume percent. Porosity of the surface can often be increased by using (e.g. silica) particles with a larger average particle size or by using a mixture of particles with different shapes.

In some embodiments, the sintered nanoparticles are acid-sintered (e.g. silica) nanoparticles. In this embodiment, the porous layer is prepared from a coating composition that contains an acid having a pKa (H₂O) that is less than or equal to 3.5. The use of weaker acids such as those having a pKa greater than 4 (e.g., acetic acid) can result in less uniform coatings. In particular, coating compositions with weaker acids such as acetic acid typically bead up on the surface of a substrate. The pKa of the acid added to the coating composition is often less than 3, less than 2.5, less than 2, less than 1.5, or less than 1. Useful acids that can be used to adjust the pH of the porous coating composition include both organic and inorganic acids. Example acids include, but are not limited to, oxalic acid, citric acid, H₂SO₃, H₃PO₄, CF₃CO₂H, HCl, HBr, HI, HBrO₃, HNO₃, HClO₄, H₂SO₄, CH₃SO₃H, CF₃SO₃H, CF₃CO₂H, and CH₃SO₂OH. In many embodiments, the acid is HCl, HNO₃, H₂SO₄, or H₃PO₄. In some embodiments, it is desirable to provide a mixture of an organic and inorganic acid. If commercially available acidic silica sols are used, the addition of a stronger acid can improve the uniformity of the porous layer.

For embodiments wherein the sintered nanoparticles are acid-sintered (e.g. silica) nanoparticles, the coating composition generally contains sufficient acid to provide a pH no greater than 5. The pH is often no greater than 4.5, no greater than 4, no greater than 3.5, or no greater than 3. For example, the pH is often in the range of 2 to 5. In some embodiments, the coating composition can be adjusted to a pH in the range of 5 to 6 after first reducing the pH to less than 5. This pH adjustment can allow the coating of more pH sensitive substrates.

The porous layer coating composition containing the acidified (e.g. silica) nanoparticles usually is applied to a substrate surface and then dried. In many embodiments, the porous layer coating composition contains (a) (e.g. silica) nanoparticles having an average particle diameter (i.e., average particle diameter prior to acid-sintering) no greater than 40 nanometers and (b) an acid with a pKa (H₂O) that is less than or equal to 3.5. The pH of the porous layer coating composition often is less than or equal to 5 such as in the pH range of 2 to 5.

The acidified (e.g. silica) nanoparticles exhibits a stable appearance when the pH is in the range 2 to 4. Light-scattering measurements have demonstrated that the acidified silica nanoparticles at pH in the range of 2 to 3 and at a concentration of 10 weight percent silica nanoparticles can retain the same size for more than a week or even more than a month. Such acidified porous layer coating compositions are expected to remain stable even longer if the concentration of silica nanoparticles is lower than 10 weight percent.

In other embodiments, the sintered nanoparticles are base sintered (e.g. silica) nanoparticles. In this embodiment, the porous layer can be prepared from a nanoparticle sol having a pH of greater than 8, 8.5, 9, 9.5, or 10 and the sintered nanoparticles may be characterized as base-sintered (e.g. silica) nanoparticles.

Suitable organic bases include but are not limited to, amidines, guanidines (including substituted guanidines such as biguanides), phosphazenes, proazaphosphatranes (also known as Verkade's bases), alkyl ammonium hydroxide, and combinations thereof. Self-protonatable forms of the bases (for example, aminoacids such as arginine) generally are less suitable, as such forms tend to be at least partially self-neutralized. Preferred bases include amidines, guanidines, and combinations thereof.

The organic bases can be used in the curable composition singly (individually) or in the form of mixtures of one or more different bases (including bases from different structural classes). If desired, the base(s) can be present in latent form, for example, in the form of an activatable composition that, upon exposure to heat, generates the base(s) in situ.

Useful amidines include those that can be represented by the following general formula:

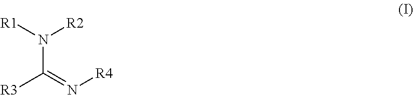

wherein R1, R2, R3, and R4 are each independently selected from hydrogen, monovalent organic groups, monovalent heteroorganic groups (for example, comprising nitrogen, oxygen, phosphorus, or sulfur in the form of groups or moieties that are bonded through a carbon atom and that do not contain acid functionality such as carboxylic or sulfonic), and combinations thereof; and wherein any two or more of R1, R2, R3, and R4 optionally can be bonded together to form a ring structure (preferably, a five-, six-, or seven-membered ring; more preferably, a six- or seven-membered ring. The organic and heteroorganic groups preferably have from 1 to 20 carbon atoms (more preferably, from 1 to 10 carbon atoms; most preferably, from 1 to 6 carbon atoms).

Amidines comprising at least one ring structure (that is, cyclic amidines) are generally preferred. Cyclic amidines comprising two ring structures (that is, bicyclic amidines) are more preferred.

Representative examples of useful amidine compounds include 1,2-dimethyl-1,4,5,6-tetrahydropyrimidine, 1-ethyl-2-methyl-1,4,5,6-tetrahydropyrimidine, 1,2-diethyl-1,4,5,6-tetrahydropyrimidine, 1-n-propyl-2-methyl-1,4,5,6-tetrahydropyrimidine, 1-isopropyl-2-methyl-1,4,5,6-tetrahydropyrimidine, 1-ethyl-2-n-propyl-1,4,5,6-tetrahydropyrimidine, 1-ethyl-2-isopropyl-1,4,5,6-tetrahydropyrimidine, DBU (that is, 1,8-diazabicyclo[5.4.0]-7-undecene), DBN (that is, 1,5-diazabicyclo[4.3.0]-5-nonene), and the like, and combinations thereof. Preferred amidines include 1,2-dimethyl-1,4,5,6-tetrahydropyrimidine, DBU (that is, 1,8-diazabicyclo[5.4.0]-7-undecene), DBN (that is, 1,5-diazabicyclo[4.3.0]-5-nonene), and combinations thereof, with DBU, DBN, and combinations thereof being more preferred and with DBU being most preferred.

Other useful organic bases are described in WO2013/127054; incorporated herein by reference.

The porous layer is generally prepared by coating an inorganic oxide (e.g. silica) nanoparticle sol on a surface of a substrate. A sol is a colloidal suspension of the nanoparticles in a continuous liquid medium. Thus, the sol is utilized as a coating composition. The sol typically comprises water or a mixture of water plus a water-miscible organic solvent. Suitable water-miscible organic solvents include, but are not limited to, various alcohols (e.g., ethanol or isopropanol) and glycols (e.g., propylene glycol), ethers (e.g., propylene glycol methyl ether), ketones (e.g., acetone), and esters (e.g., propylene glycol monomethyl ether acetate). The (e.g. silica) nanoparticles included in the porous layer coating compositions are typically are not surface modified.

In some embodiments, optional silane coupling agents, that contain a plurality of reactive silyl groups, can be added to the porous layer coating compositions. Some example coupling agents include, but are not limited to, tetraalkoxysilanes (e.g., tetraethylorthosilicate (TEOS)) and oligomeric forms of tetraalkoxysilane such as alkyl polysilicates (e.g., poly(diethoxysiloxane). These coupling agents may, at least in some embodiments, improve binding between silica particles. If added, the coupling agent is typically added to the porous layer coating composition in an amount of 1 to 10 or 1 to 5 weight percent based on the weight of silica particles. However, in typical embodiments, the porous layer (i.e. prior to deposition of the hydrophobic layer) is free of silane coupling agent such as tetraalkoxysilanes (e.g., tetraethylorthosilicate (TEOS)) and oligomeric forms of tetraalkoxysilane such as alkyl polysilicates (e.g., poly(diethoxysiloxane).

The sol coating compositions can be applied directly to any substrate. The substrate can be an organic material (e.g., polymeric) or inorganic material (e.g., glass, ceramic, or metal). The surface energy of the substrate surface may be increased by oxidizing the substrate surface prior to coating using methods such as corona discharge or flame treatment methods. These methods may also improve adhesion of the porous layer to the substrate. Other methods capable of increasing the surface energy of the substrate include the use of primer layers such as thin coatings of polyvinylidene chloride (PVDC). Alternatively, the surface tension of the porous layer coating composition may be decreased by addition of lower alcohols (e.g., alcohols having 1 to 8 carbon atoms, 1 to 6 carbon atoms, or 1 to 4 carbon atoms).

In some embodiments a surfactant may be included in the (e.g. sol) coating composition. Surfactants are molecules having both hydrophilic (polar) and hydrophobic (non-polar) regions and that are capable of reducing the surface tension of the porous layer coating composition. Useful surfactants include anionic surfactants, cationic surfactants, and nonionic surfactants. Various surfactants can be utilized, such as described in US2013/0216820, US2014/0120340 and WO2013/127054; incorporated herein by reference.

When added, the surfactant is typically present in an amount up to 5 weight percent based on a total weight of the porous layer coating composition. For example, the amount can be up to 4 weight percent, up to 2 weight percent, or up to 1 weight percent. The surfactant is typically present in an amount equal to at least 0.001 weight percent, at least 0.005 weight percent, at least 0.01 weight percent, at least 0.05 weight percent, at least 0.1 weight percent, or at least 0.5 weight percent. However, in some embodiments, the porous layer is substantially free of surfactant. Surfactants can interfere with adhesion of the porous layer to the substrate and/or the hydrophobic layer.

The (e.g. sol) coating compositions are typically applied to the surface of the substrate using conventional techniques such as, for example, bar coating, roll coating, curtain coating, rotogravure coating, knife coating, spray coating, spin coating, or dip coating techniques. Coating techniques such as bar coating, roll coating, and knife coating are often used to adjust the thickness of the coating composition. The coating compositions can be coated on one or more sides of the substrate.

The average dry coating thickness of the porous layer is dependent upon the particular porous layer coating composition used. In general, the average thickness of the dry and sintered porous layer is typically at least 25, 30, 35, 40, 45 or 50 nm and often no greater than about 5, 4, 3, 2, or 1 micron. In some embodiments, the thickness is no greater than 500, 400, or 300 nm. In other embodiments, the thickness is no greater than 250, 200, or 100 nm. The thickness can be measured using an ellipsometer such as a Gaertner Scientific Corp. Model No. L115C. The mechanical properties of the porous layer often improve as the thickness is increased.

Although the actual coating thickness can vary considerably from one particular point to another, it is often desirable to apply the porous layer coating composition uniformly over the surface of the substrate. In some embodiments, it may be desirable to control the average coating thickness within 200 Å, within 150 Å, or within 100 Å. The particle size of the nanoparticles and larger particles affects the ability to achieve a thin, uniform coating. Thus, in some embodiments, the thickness of the coating is greater than the maximum particle size of the nanoparticles and larger particles.

Once applied to the substrate, the coating composition is typically dried at temperatures in a range from 20° C. to 250° C. In some embodiments, the coating composition is dried at a temperature no greater than 225° C., 200° C., 175° C., 150° C., 125° C. or 100° C. An oven with circulating air or inert gas such as nitrogen is often used for drying purposes. The temperature may be increased further to speed the drying process, but care should be exercised to avoid damage to the substrate. For inorganic substrates, the drying temperature can be above 200° C.

The dried porous layer refers to the porous layer remaining after the drying process. After the (e.g. sol) coating composition is applied to the substrate, a gelled material forms as the sol dries and the (e.g. silica) acidified nanoparticles sinter to form the continuous network. Thus, in this embodiment, the drying temperature is also the temperature at which the sintering occurs. Micrographs reveal the formation of “necks” between adjacent nanoparticles that are created even in the absence of other silicon-containing materials such as the silane coupling agents. The formation of these necks is attributed to the catalytic action of strong acid or strong base in making and breaking siloxane bonds.

Alternatively, for substrates having sufficient heat resistance, the inorganic oxide (silica) particles can be thermally sintered, typically at temperatures substantially greater than 200° C. For example it is common to thermally sinter (e.g. silica) particles at temperatures of greater than 300° C., 400° C., or 500° C. ranging up to 1000° C.

The dried porous layer can contain some water such as the amount of water typically associated with equilibrium of the porous layer with the atmospheric moisture present in the environment of the porous layer. This equilibrium amount of water is typically no greater than 5 weight percent, no greater than 3 weight percent, no greater than 2 weight percent, no greater than 1 weight percent, or no greater than 0.5 weight percent based on a total weight of the dried porous layer.

A hydrophobic layer is disposed on a surface of the porous three-dimensional network of the sintered inorganic oxide (e.g. silica) particles. This is accomplishing by coating a surface of the sintered porous layer with a hydrophobic material.

The selection of hydrophobic material is typically based on the selection of lubricant. In typical embodiments, the hydrophobic layer comprises a material of the same chemical class as the lubricant. For example, when the hydrophobic layer comprises a fluorinated material (e.g. comprising a fluorinated group), the lubricant is typically a fluorinated liquid. Likewise, when the hydrophobic layer comprises a hydrocarbon material (e.g. comprising a hydrocarbon group), the lubricant is typically a hydrocarbon liquid. Further, when the hydrophobic layer comprises a silane or siloxane material (lacking long chain alkyl groups), the lubricant is typically a silicone fluid.

In some embodiments, the hydrophobic layer may comprise an organic polymeric material such as polydimethylsiloxane or a fluoropolymer composed of tetrafluoroethylene, optionally in combination with hexafluoropropylene and/or vinylidene fluoride.

However, in typical embodiments, the hydrophobic layer is bonded to the porous layer. In this embodiment, the hydrophobic layer comprises a compound having the general formula A-B or A-B-A, wherein A is an inorganic group capable of bonding with the sintered (e.g. silica) particles and B is a hydrophobic group. In some embodiments, A is a reactive silyl group. The (e.g. silane) hydrophobic surface treatment compounds are typically covalently bonded to the porous layer through a —Si—O—Si— bond. Suitable hydrophobic groups include aliphatic or aromatic hydrocarbon groups, fluorinated groups such a polyfluoroether, polyfluoropolyether and perfluroalkane.

In some embodiments, the silane compound used to form the hydrophobic layer is of Formula (I).

R_{f}-[Q-[C(R¹)₂—Si(R²)₃₋ₓ(R³)ₓ]_{y}]_{z} (I)

In Formula (I), group R_{f} is a z-valent radical of a perfluoroether, perfluoropolyether, or perfluoroalkane (i.e., R_{f} is (a) a monovalent or divalent radical of a perfluoroether, (b) a monovalent or divalent radical of a perfluoropolyether, or (c) a monovalent or divalent radical of a perfluoroalkane). Group Q is a single bond, a divalent linking group, or trivalent linking group. Each group R¹ is independently hydrogen or alkyl. Each group R² is independently hydroxyl or a hydrolyzable group. Each group R³ is independently a non-hydrolyzable group. The variable x is an integer equal to 0, 1, or 2. The variable y is an integer equal to 1 or 2. The variable z is an integer equal to 1 or 2.

Group R_{f} is a z-valent radical of a polyether, a z-valent radical of a perfluoropolyether, or a z-valent radical of a perfluoroalkane. As used herein, the term “z-valent radical” refers to a radical having a valence equal to the variable z. Because z is in integer equal to 1 or 2, a z-valent radical is a monovalent or divalent radical. Thus, R_{f} is (a) a monovalent or divalent radical of a perfluoroether, (b) a monovalent or divalent radical of a perfluoropolyether, or (c) a monovalent or divalent radical of a perfluoroalkane.

If the variable z in Formula (I) is equal to 1, the fluorinated silane is of Formula (Ia) where group R_{f} is a monovalent group.

R_{f}-Q-[C(R¹)₂—Si(R²)₃₋ₓ(R³)ₓ]_{y} (Ia)

Such a compound can be referred to as a monopodal fluorinated silane because there is a single end group of formula -Q-[C(R¹)₂—Si(R²)₃₋ₓ(R³)ₓ]_{y}. There can be a single silyl group if the variable y is equal to 1 or two silyl groups if the variable y is equal to 2.

If the variable z in Formula (I) is equal to 2, the fluorinated silane is of Formula (Ib) where group R_{f} is a divalent group.

R_{f}-[Q-[C(R¹)₂—Si(R²)₃₋ₓ(R³)ₓ]_{y}]₂ (Ib)

Such a compound can be referred to as a bipodal fluorinated silane because there are two end groups of formula -Q-[C(R¹)—Si(R²)₃₋ₓ(R³)ₓ]_{y}. Each end group can have a single silyl group if the variable y is equal to 1 or two silyl groups if the variable y is equal to 2. Formula (Ib) can be written as the following equivalent formula that emphasizes the divalent nature of the R_{f} group.

[(R³)ₓ(R²)₃₋ₓSi—C(R¹)₂]_{y}-Q-R_{f}-Q-[C(R¹)₂—Si(R²)₃₋ₓ(R³)ₓ]_{y}

Any suitable perfluorinated group can be used for R_{f}. The perfluorinated group is typically a monovalent or divalent radical of a perfluoroether, perfluoropolyether, or perfluoroalkane. This group can have a single carbon atom but often has at least 2 carbon atoms, at least 4 carbon atoms, at least 6 carbon atoms, at least 8 carbon atoms, or at least 12 carbon atoms. The R_{f} group often has up to 300 or more carbon atoms, up to 200 carbon atoms, up to 100 carbon atoms, up to 80 carbon atoms, up to 60 carbon atoms, up to 50 carbon atoms, up to 40 carbon atoms, up to 20 carbon atoms, or up to 10 carbon atoms. The R_{f} group is usually saturated and can be linear, branched, cyclic (e.g., alicyclic), or a combination thereof.

R_{f} groups that are monovalent or divalent radicals of a perfluoroether or perfluoropolyether often contains at least one perfluorinated unit selected from —C_{b}F_{2b}O—, —CF(Z)O—, —CF(Z)C_{b}F_{2b}O—, —C_{b}F_{2b}CF(Z)O—, —CF₂CF(Z)O—, or combinations thereof. The variable b is an integer equal to at least 1. For example, the variable b can be an integer in the range of 1 to 10, in the range of 1 to 8, in the range of 1 to 4, or in the range of 1 to 3. The group Z is a perfluoroalkyl, perfluoroalkoxy, perfluoroether, or perfluoropolyether group. Any of these Z groups can be linear, branched, cyclic, or a combination thereof. Example perfluoroalkyl, perfluoralkoxy, perfluoroether, and perfluoropolyether Z groups often have up to 20 carbon atoms, up to 16 carbon atoms, up to 12 carbon atoms, up to 8 carbon atoms, or up to 4 carbon atoms. Perfluoropolyether groups for Z can have, for example, up to 10 oxygen atoms, up to 8 oxygen atoms, up to 6 oxygen atoms, up to 4 oxygen atoms, or up to 3 oxygen atoms. In some embodiments, Z is a —CF₃ group.

Monovalent perfluoroether groups are of general formula R_{f}¹—O—R_{f}²— where R_{f}¹ is a perfluoroalkyl and R_{f}² is a perfluoroalkylene. R_{f}¹ and R_{f}² each independently have at least 1 carbon atoms and often have at least 2 carbon atoms, at least 3 carbon atoms, or at least 4 carbon atoms. Groups R_{f}¹ and R_{f}² each independently can have up to 50 carbon atoms, up to 40 carbon atoms, up to 30 carbon atoms, up to 25 carbon atoms, up to 20 carbon atoms, up to 16 carbon atoms, up to 12 carbon atoms, up to 10 carbon atoms, up to 8 carbon atoms, up to 4 carbon atoms, or up to 3 carbon atoms. In many embodiments, the perfluoroalkylene groups and/or the perfluoroalkyl groups have 1 to 10 carbon atoms, 1 to 8 carbon atoms, 1 to 6 carbon atoms, 1 to 4 carbon atoms, or 1 to 3 carbon atoms.

Monovalent perfluoroether groups often have a terminal group (i.e., R_{f}¹—O— group) of formula C_{b}F_{2b+1}O—, CF₂(Z¹)O—, CF₂(Z¹)C_{b}F_{2b}O—, C_{b}F_{2b+1}CF(Z¹)O—, or CF₃CF(Z¹)O— where b is the same as defined above. The group Z¹ is a perfluoroalkyl having up to 20 carbon atoms, up to 16 carbon atoms, up to 12 carbon atoms, up to 8 carbon atoms, up to 6 carbon atoms, or up to 4 carbon atoms. In some embodiments, Z¹ is a —CF₃ group. The terminal group is directly bonded to a perfluoroalkylene group. The perfluoroalkylene group can be linear or branched and often has up to 20 carbon atoms, up to 16 carbon atoms, up to 12 carbon atoms, up to 8 carbon atoms, or up to 4 carbon atoms. Specific examples of perfluoroether groups include, but are not limited to, CF₃CF₂OCF₂CF₂CF₂—, CF₃OCF₂CF₂CF₂—, C₃F₇OCF₂CF₂CF₂—, CF₃CF₂OCF(CF₃)CF₂—, CF₃OCF(CF₃)CF₂—, and C₃F₇OCF(CF₃)CF₂—.

Divalent perfluoroether groups are of general formula —R_{f}²—O—R_{f}³— where R_{f}² and R_{f}³ are each independently a perfluoroalkylene. Each perfluoroalkylene independently has at least 1 carbon atom, at least 2 carbon atoms, at least 3 carbon atoms, or at least 4 carbon atoms. Groups R_{f}² and R_{f}³ each independently can have up to 50 carbon atoms, up to 40 carbon atoms, up to 30 carbon atoms, up to 25 carbon atoms, up to 20 carbon atoms, up to 16 carbon atoms, up to 12 carbon atoms, up to 10 carbon atoms, up to 8 carbon atoms, up to 4 carbon atoms, or up to 3 carbon atoms. In many embodiments, each perfluoroalkylene group has 1 to 10 carbon atoms, 1 to 8 carbon atoms, 1 to 6 carbon atoms, 1 to 4 carbon atoms, 1 to 3 carbon atoms, or 1 to 2 carbon atoms.

Monovalent perfluoropolyether groups are of general formula R_{f}¹—O—(R_{f}²—O)ₐ—R_{f}³— where R_{f}¹ is a perfluoroalkyl, R_{f}² and R_{f}³ are each independently a perfluoroalkylene, and the variable a is an integer equal to at least 1. Groups R_{f}¹, R_{f}², and R_{f}³ are the same as defined above for perfluoroether groups. The variable a is any integer in the range of 1 to 50, in the range of 1 to 40, in the range of 1 to 30, in the range of 1 to 25, in the range of 1 to 20, or in the range of 1 to 10.

Monovalent perfluoropolyether groups often have a terminal group (i.e., R_{f}¹—O— group) of formula C_{b}F_{2b+1}O—, CF₂(Z)O—, CF₂(Z)C_{b}F_{2b}O—, C_{b}F_{2b+1}CF(Z)O—, or CF₃CF(Z)O— where b and Z are the same as defined above. The terminal group is directly bonded to at least one perfluoroalkyleneoxy or poly(perfluoroalkyleneoxy) group (i.e., —(R_{f}²—O)ₐ— group). Each perfluoroalkyleneoxy group often has 1 to 10 carbon atoms, 1 to 8 carbon atoms, 1 to 6 carbon atoms, 1 to 4 carbon atoms, or 1 to 3 carbon atoms. The perfluoroalkyleneoxy or poly(perfluoroalkyleneoxy) group is directly bonded to a perfluoroalkylene group (i.e., —R_{f}³—).

Representative examples of useful monovalent perfluoropolyether groups or terminal groups of monovalent perfluoropolyether groups include, but are not limited to, C₃F₇O(CF(CF₃)CF₂O)ₙCF(CF₃)—, C₃F₇O(CF(CF₃)CF₂O)ₙCF₂CF₂—, C₃F₇O(CF₂CF₂CF₂O)ₙCF₂CF₂—, C₃F₇O(CF₂CF₂CF₂O)ₙCF(CF₃)—, CF₃O(C₂F₄O)ₙCF₂—, CF₃O(CF₂O)ₘ(C₂F₄O)_{q}CF₂—, F(CF₂)₃O(C₃F₆O)ₙ(CF₂)₃—, and CF₃O(CF₂CF(CF₃)O)ₙ(CF₂O)X—. The group X is usually —CF₂—, —C₂F₄—, —C₃F₆—, or —C₄F₈—. The variable n is an integer that is often in the range of 1 to 50, in the range of 1 to 40, in the range of 1 to 30, in the range of 3 to 30, in the range of 1 to 20, in the range of 3 to 20, in the range of 1 to 10, or in the range of 3 to 10. Provided that the sum (m+q) is equal to at least one, the variables m and q can each independently be in the range of 0 to 50, in the range of 0 to 40, in the range of in the range of 0 to 30, in the range of 1 to 30, in the range of 3 to 20, or in the range of 3 to 10. The sum (m+q) is often in the range of 1 to 50, in the range of 1 to 40, in the range of 1 to 30, in the range of 3 to 20, in the range of 1 to 20, in the range of 3 to 20, in the range of 1 to 10, or in the range of 3 to 10.

Representative examples of divalent perfluoropolyether groups or segments include, but are not limited to, —CF₂O(CF₂O)ₘ(C₂F₄O)_{q}CF₂—, —CF₂O(C₂F₄O)ₙCF₂—, —(CF₂)₃O(C₄F₈O)ₙ(CF₂)₃—, —CF(CF₃)O(CF₂CF₂CF₂O)ₙCF₂CF₂—, —CF(CF₃)O(CF₂CF₂CF₂O)ₙCF(CF₃)—, —(CF₂)₃O(C₃F₆O)ₙ(CF₂)₃— and —CF(CF₃)(OCF₂CF(CF₃))ₘOCₜF₂ₜO(CF(CF₃)CF₂O)_{q}CF(CF₃)—. The variables n, m, and q are the same as defined above. The variable t is an integer in the range of 2 to 8, in the range of 2 to 6, in the range of 2 to 4, or in the range of 3 to 4.

In many embodiments, the perfluoropolyether (whether monovalent or divalent) includes at least one divalent hexafluoropropyleneoxy group (—CF(CF₃)—CF₂O— or —CF₂CF₂CF₂O—). Segments with —CF(CF₃)—CF₂O— can be obtained through the oligomerization of hexafluoropropylene oxide and can be preferred because of their relatively benign environmental properties. Segments with —CF₂CF₂CF₂O— can be obtained by anionic oligomerization of tetrafluorooxetane followed by direct fluorination. Example hexafluoropropyleneoxy groups include, but are not limited to, C₃F₇O(CF(CF₃)CF₂O)ₙCF(CF₃)—, C₃F₇O(CF(CF₃)CF₂O)ₙCF₂CF₂—, C₃F₇O(CF₂CF₂CF₂O)ₙCF₂CF₂—, C₃F₇O(CF₂CF₂CF₂O)ₙCF(CF₃)—, —CF(CF₃)O(CF(CF₃)CF₂O)ₙCF(CF₃)—, —CF(CF₃)O(CF(CF₃)CF₂O)ₙCF₂CF₂—, —CF(CF₃)O(CF₂CF₂CF₂O)ₙCF₂CF₂—, —CF(CF₃)O(CF₂CF₂CF₂O)ₙCF(CF₃)—, and —CF(CF₃)(OCF₂CF(CF₃))ₘOCₜF₂ₜO(CF(CF₃)CF₂O)_{q}CF(CF₃)—. The variables n, m, q, and t are the same as defined above.

Frequently, the compounds of Formula (I) are present as a mixture of materials having R_{f} groups of the same basic structure but with a different number of carbon atoms. For example, the compounds of Formula (I) can be a mixture of materials having different variables m, n, and/or q in the above example monovalent and divalent perfluoropolyether groups. As such, the number of repeating groups is often reported as an average number that may not be an integer.

The group Q in Formula (I) is a single covalent bond, a divalent linking group, or a trivalent linking group. If Q is a single bond, the variable y is equal to 1. For compounds of Formula (Ia) with a monovalent R_{f} group, if Q is a single covalent bond and y is equal to 1, the compounds are of Formula (Ia-1).

R_{f}—C(R¹)₂—Si(R²)₃₋ₓ(R³)ₓ (Ia-1)

Similarly, for compounds of Formula (Ib) with a divalent R_{f} group, if Q is a single covalent bond and y is equal to 1, the compounds are of Formula (Ib-1).

R_{f}—[C(R¹)₂—Si(R²)₃₋ₓ(R³)ₓ]₂ (Ib-1)

If the group Q is a divalent linking group, the variable y is equal to 1. For compounds of Formula (Ia) with a monovalent R_{f} group, if Q is a divalent group and y is equal to 1, the compounds are of Formula (Ia-2).

R_{f}-Q-C(R¹)₂—Si(R²)₃₋ₓ(R³)ₓ (Ia-2)

Similarly, for compounds of Formula (Ib) with a divalent R_{f} group, if Q is a divalent group and y is equal to 1, the compounds are of Formula (Ib-2).

R_{f}-[Q-C(R¹)₂—Si(R²)₃₋ₓ(R³)ₓ]₂ (Ib-2)

If the group Q is a trivalent linking group, the variable y is usually equal to 2. For compounds of Formula (Ia) with a monovalent R_{f} group, if Q is a trivalent group and y is equal to 2, the compounds are of Formula (Ia-3). There are two groups of formula —C(R¹)₂—Si(R²)₃₋ₓ(R³)ₓ.

R_{f}-Q-[C(R¹)₂—Si(R²)₃₋ₓ(R³)ₓ]₂ (Ia-3)

Similarly, for compounds of Formula (Ib) with a divalent R_{f} group, if Q is a trivalent group and y is equal to 2, the compounds are of Formula (Ib-3).

R_{f}-[Q-[C(R¹)₂—Si(R²)₃₋ₓ(R³)ₓ]₂]₂ (Ib-3)

Group Q typically includes at least one alkylene group (e.g., an alkylene having 1 to 30 carbon atoms, 1 to 20 carbon atoms, 1 to 12 carbon atoms, 1 to 10 carbon atoms, 1 to 6 carbon atoms, or 1 to 4 carbon atoms) plus optional groups selected from oxy, thio, —NR⁴—, methine, tertiary nitrogen, quaternary nitrogen, carbonyl, sulfonyl, sulfiryl, carbonyloxy, carbonylthio, carbonylimino, sulfonylimino, oxycarbonyloxy, iminocarbonylimino, oxycarbonylimino, or a combination thereof. Group R⁴ is hydrogen, alkyl (e.g., an alkyl having 1 to 10 carbon atoms, 1 to 6 carbon atoms, or 1 to 4 carbon atoms), aryl (e.g., an aryl having 6 to 12 carbon atoms such as phenyl or biphenyl), or aralkyl (e.g., an aralkyl having an alkyl group with 1 to 10 carbon atoms, 1 to 6 carbon atoms, or 1 to 4 carbon atoms and an aryl group with 6 to 12 carbon atoms such as phenyl). If the compound of Formula (I) has multiple Q groups, the Q groups can be the same or different. In many embodiments with multiple Q groups, these groups are the same.

In some embodiments, group Q includes an alkylene having at least 1 or at least 2 carbon atoms directly bonded to the —C(R¹)— group in Formula (I). The presence of such an alkylene group tends to provide stability against hydrolysis and other chemical transformations such as nucleophilic attack.

Some divalent Q groups are an alkylene group of formula —(CH₂)ₖ— where each variable k is independently an integer greater than 1, greater than 2, or greater than 5. For example, k can be an integer in the range of 1 to 30, in the range of 1 to 25, in the range of 1 to 20, in the range of 1 to 15, in the range of 2 to 15, in the range of 2 to 12, in the range of 1 to 10, in the range of 1 to 6, or in the range of 1 to 4. Specific examples include, but are not limited to, —CH₂— and —CH₂CH₂—. Such groups are typical for Q when R_{f} is a monovalent or divalent radical of a perfluoroalkane.

Some divalent Q groups include a single alkylene group directly bonded to one or more of the optional groups. Such groups can be of formula —(CO)N(R⁴)—(CH₂)ₖ— where the alkylene is bonded to a carbonylimino group, —O(CO)N(R⁴)—(CH₂)ₖ— where the alkylene is bonded to a oxycarbonylimino group, —(CO)S—(CH₂)ₖ— where the alkylene is linked to a carbonylthio, or —S(O)₂N(R⁴)—(CH₂)ₖ— where the alkylene is linked to a sulfonylimino group. The variable k and the group R⁴ are the same as described above. Some more specific groups include, for example, —(CO)NH(CH₂)₂—, or —O(CO)NH(CH₂)₂—. In these Q groups, the alkylene group is also bonded to the —C(R¹)₂— group.

Other suitable Q groups are described in US2013/021680; incorporated herein by reference.

Some specific fluorinated silanes where R_{f} is a monovalent or divalent radical of a perfluoroether or perfluoropolyether are of formula R_{f}—(CO)N(R⁴)—(CH₂)ₖ—CH₂—Si(R²)₃, of formula R_{f}—[(CO)N(R⁴)—(CH₂)ₖ—CH₂—Si(R²)₃]₂, or a mixture thereof. The variable k is the same as defined above. In some embodiments, k is in the range of 1 to 10, in the range of 1 to 6, or in the range of 1 to 4. Some more particular fluorinated silanes of formula R_{f}—(CO)N(R⁴)—CH₂)ₖ—CH₂—Si(R²)₃ include, but are not limited to, F(CF(CF₃)CF₂O)ₐCF(CF₃)—CONHCH₂CH₂CH₂Si(OCH₃)₃ where a is a variable in a range of 4 to 20 and CF₃OC₂F₄OC₂F₄OCF₂CONHC₃H₆Si(OEt)₃. A more particular example of formula R_{f}—[(CO)N(R⁴)—CH₂)ₖ—CH₂—Si(R²)₃]₂ is a compound of formula

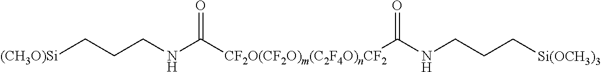

where n and m are each a variable in a range of about 9 to 10.

Some specific fluorinated silanes where R_{f} is a monovalent or divalent radical of a perfluoroalkane are of formula R_{f}—(CH₂)ₖ—CH₂—Si(R²)₃, or formula R_{f}—[(CH₂)ₖ—CH₂—Si(R²)₃]₂, or a mixture thereof. The variable k is the same as defined above. More specific fluorinated silanes are of formula R_{f}—(CH₂)₂—Si(R²)₃, or formula R_{f}—[(CH₂)₂—Si(R²)₃]₂, or a mixture thereof.

The above-described fluorinated silane compounds can be synthesized using standard techniques, as described in previously cited US2013/021680.

In some embodiments, the silane compound used to form the hydrophobic layer is of Formula (II).

R¹L[Si(R²)₃₋ₓ(R³)ₓ]_{y} (II)

In Formula (I), group R¹ is an aliphatic or aromatic hydrocarbon group. L is a covalent bond or divalent organic linking group such as a urethane group. Each R² is independently hydroxyl or a hydrolyzable group. Each R³ is independently a non-hydrolyzable group. Each variable x is an integer equal to 0, 1, or 2. The variable y is an integer equal to 1 or 2.

If the variable y in Formula (I) is equal to 1, group R¹ is monovalent and Formula (I) is equal to Formula (Ia).

R¹LSi(R²)₃₋ₓ(R³)ₓ (IIa)

If the variable y in Formula (I) is equal to 2, group R¹ is divalent and Formula (I) is equal to Formula (Ib).

(R³)ₓ(R²)₃₋ₓSiLR¹LSi(R²)₃₋ₓ(R³)ₓ (IIb)

Suitable divalent groups include alkylene, arylene, or a combination thereof.

Each of the described silane compounds has at least one group of formula —Si(R²)₃₋ₓ(R³)ₓ. Each group R² is independently hydroxyl or a hydrolyzable group. Each group R³ is independently a non-hydrolyzable group. The variable x is an integer equal to 0, 1, or 2. The silane compound has a single silyl group if R¹ is monovalent and two silyl groups if R¹ is divalent.

In some embodiments, R¹ is a (e.g. linear or branched) alkyl or alkylene group having at least 1 carbon atom, at least 2 carbon atoms, at least 3 carbon atoms, at least 4 carbon atoms, or at least 5 carbon atoms and can have, for example, up to 40 carbon atoms, up to 35 carbon atoms, up to 30 carbon atoms, up to 25 carbon atoms, up to 20 carbon atoms, up to 15 carbon atoms, or up to 10 carbon atoms. Suitable aryl and arylene R¹ groups often have 6 to 18 carbon atoms, 6 to 12 carbon atoms, or 6 to 10 carbon atoms. Some example aryl groups are phenyl, diphenyl, and naphthyl. Some examples of arylene groups are phenylene, diphenylene, and naphthylene.

Examples silane compounds wherein R¹ is a hydrocarbon group include, but are not limited to, C₁₀H₂₁—Si(OC₂H₅)₃, C₁₈H₃₇—Si(OC₂H₅)₃, C₁₈H₃₇—Si(Cl)₃, C₈H₁₇—Si(Cl)₃, and CH₃—Si(Cl)₃, (CH₃O)₃Si—C₈H₁₆—Si(OCH₃)₃, (C₂H₅O)₃Si—C₂H₄—Si(OC₂H₅)₃, (CH₃O)₃Si—CH₂CH(C₈H₁₇)—Si(OCH₃)₃, C₆H₅—Si(OCH₃)₃, C₆H₅—Si(Cl)₃, C₁₀H₇—Si(OC₂H₅)₃, and (CH₃O)₃Si—C₂H₄—C₆H₄—C₂H₄—Si(OCH₃)₃.

In some embodiments, R¹ is a (e.g. linear or branched) alkyl or alkylene group having at least 5, 6, 7, or 8 carbon atoms. Compounds of this type are generally preferred for use with hydrocarbon lubricants. In addition to some of the silane compounds described above, suitable silane compounds include triacontyldimethylchlorosilane and 13-(chlorodimethylsilylmethyl)-heptanosane.

In another embodiment, the hydrophobic compound is the reaction product of a diol comprising an alkylene group, as previously described, and an isocyanto functional alkyl trialkoxy silane. One suitable diol is PRIPOL 2033, depicts as follows:

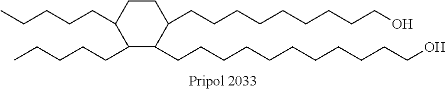 [SMILES: CCCCCC1CCC(CCCCCCCCCO)C(CCCCCCCCCCCO)C1CCCCC]

The OH groups of the dimer diol are converted to the group -L[Si(R²)₃₋ₓ(R³)ₓ]_{y}, wherein L is a urethane linkage.

In each group of formula —Si(R²)₃₋ₓ(R³)ₓ, there can be one, two, or three R² groups. The R² group is the reaction site for reaction with the sintered (e.g. silica) particles included in the porous layer. That is, the hydrolyzable group or hydroxyl group reacts with the surface of the sintered (e.g. silica) particles to covalently attach the silane compound to the porous layer resulting in the formation of a —Si—O—Si— bond. Suitable hydrolyzable R² groups include, for example, alkoxy, aryloxy, aralkyloxy, acyloxy, or halo groups. Suitable alkoxy groups often have 1 to 10 carbon atoms, 1 to 6 carbon atoms, 1 to 4 carbon atoms, or 1 to 3 carbon atoms. Suitable aryloxy groups often have 6 to 12 carbon atoms or 6 to 10 carbon atoms such as, for example, phenoxy. Suitable aralkyloxy group often have an alkoxy group with 1 to 10 carbon atoms, 1 to 6 carbon atoms, or 1 to 4 carbon atoms and an aryl group with 6 to 12 carbon atoms or 6 to 10 carbon atoms. An example aralkyloxy group has an alkoxy group with 1 to 4 carbon atoms with a phenyl group covalently attached to the alkoxy group. Suitable halo groups can be chloro, bromo, or iodo but are often chloro. Suitable acyloxy groups are of formula —O(CO)R^{b} where R^{b} is alkyl, aryl, or aralkyl. Suitable alkyl R^{b} groups often have 1 to 10 carbon atoms, 1 to 6 carbon atoms, or 1 to 4 carbon atoms. Suitable aryl R^{b} groups often have 6 to 12 carbon atoms or 6 to 10 carbon atoms such as, for example, phenyl. Suitable aralkyl R^{b} groups often have an alkyl group with 1 to 10 carbon atoms, 1 to 6 carbon atoms, or 1 to 4 carbon atoms that is substituted with an aryl having 6 to 12 carbon atoms or 6 to 10 carbon atoms such as, for example, phenyl. When there are multiple R² groups, they can be the same or different. In many embodiments, each R² is an alkoxy group or chloro.

If there are fewer than three R² group in each group of formula, there is at least one R³ group. The R³ group is a non-hydrolyzable group. Many non-hydrolyzable groups are alkyl, aryl, and aralkyl groups. Suitable alkyl groups include those having 1 to 10 carbon atoms, 1 to 6 carbon atoms, or 1 to 4 carbon atoms. Suitable aryl groups often have 6 to 12 carbon atoms or 6 to 10 carbon atoms such as, for example, phenyl or biphenyl. Suitable aralkyl groups often have an alkyl group with 1 to 10 carbon atoms, 1 to 6 carbon atoms, or 1 to 4 carbon atoms substituted with an aryl having 6 to 12 carbon atoms or 6 to 10 carbon atoms such as, for example, phenyl. When there are multiple R³ groups, these groups can be the same or different. In many embodiments, each R³ is an alkyl group.

In some embodiments, a silazane compound is utilized to form the hydrophobic layer. A silazane is a hydride of silicon and nitrogen having a straight or branched chain of silicon and nitrogen atoms joined by covalent bonds. Silazane are analogous to siloxanes, with —NH— replacing —O—. Suitable silazane compounds include for example hexamethyldisilazane (HMDS); 1,1,3,3-tetramethyldisilazane; 2,2,4,4,6,6-hexamethylcyclotrisilazane; 1,3-diethyl-1,1,3,3-tetramethyldisilazane; and 1,1,3,3-tetramethyl-1,3-diphenyldisilazane.

In the presence of water (e.g. vapor), silazanes form a compound having the formula of Formula (II)

R¹[Si(R²)₃₋ₓ(R³)ₓ]_{y}

wherein R¹ and R³ are independently non-hydrolyzable groups, R² is hydroxyl, x is 2 and y is 1. In typical embodiments, R¹ and R³ are independently hydrogen, C₁-C₄ alkyl (e.g. methyl, ethyl) or phenyl.

In other embodiments, the hydrophobic material is a silanol-terminated polydimethylsiloxanes or hydroxy terminated polydimethylsiloxanes.

In some embodiments, the hydrophobic material comprises silane or siloxane compounds comprising C₁-C₄ alkyl group that are typically free of longer chain alkyl or alkylene group in combination with a silicone lubricant.

The hydrophobic materials often can be used in neat form in the surface treatment of the sintered inorganic oxide porous layer. Alternatively, the materials can be mixed with one or more organic solvents and/or one or more other optional components.

Suitable organic solvents include, but are not limited to, aliphatic alcohols such as, for example, methanol, ethanol, and isopropanol; ketones such as, for example, acetone and methyl ethyl ketone; esters such as, for example, ethyl acetate and methyl formate; ethers such as, for example, diethyl ether, diisopropyl ether, methyl t-butyl ether, and dipropylene glycol monomethyl ether (DPM); alkanes such as, for example, heptane, decane, and other paraffinic (i.e., oleofinic) solvents; perfluorinated hydrocarbons such as, for example, perfluorohexane and perfluorooctane; fluorinated hydrocarbons such as, for example, pentafluorobutane; hydrofluoroethers such as, for example, methyl perfluorobutyl ether and ethyl perfluorobutyl ether; and the like; and combinations thereof. Preferred solvents often include aliphatic alcohols, perfluorinated hydrocarbons, fluorinated hydrocarbons, hydrofluoroethers, or combinations thereof. In some embodiments, the surface treatment composition contains aliphatic alcohols, hydrofluoroethers, or combinations thereof. In other embodiments, the hydrocarbon layer coating composition contains hydrofluoroethers or combinations thereof.

Some suitable fluorinated solvents that are commercially available include, for example, those commercially available from 3M Company (Saint Paul, Minn.) under the trade designation 3M NOVEC ENGINEERED FLUID (e.g., 3M NOVEC ENGINEERED FLUID 7100, 7200DL, and 7500).

The hydrophobic coating compositions often contain an amount of the organic solvent that can dissolve or suspend at least about 0.1 percent by weight of the hydrophobic material based on a total weight of the hydrophobic coating composition. In some embodiments, the hydrophobic material (e.g. silane) compound is present in the coating composition at an amount of at least 0.5 percent by weight and no greater than 20, 15, or 10 percent by weight. The coating composition comprising the hydrophobic (e.g. silane) compound can include other optional compounds. For example, a crosslinker can be added. The crosslinker is typically added when there are multiple silyl groups on the silane compound; as further described in previously cited Riddle et al. US2014/0120340 and US2013/0216820.

After coating a surface of the sintered porous layer with a hydrophobic compound and evaporating any solvent that is present, a lubricant is coated onto the surface treated porous layer of sintered inorganic oxide particles thereby impregnating the lubricant into pores of the surface treated porous layer. By impregnate, it is meant that the pores are saturated with the lubricant. Further, the lubricant is held in place within the pores by surface tension forces, capillary forces van der Waal forces (e.g., suction), or combinations thereof. The repellant surface layer of the substrate (or article) is typically not exposed to forces in excess of the forces that hold the lubricant in place within the pores.

The impregnating lubricant may be sprayed or brushed onto the surface treated porous layer. In one embodiment, the lubricant is applied by filling or partially filling a container that includes the substrate having the surface treated porous layer. The excess impregnating liquid is then removed from the container. Additional methods for adding the impregnating lubricant include spin coating processes and condensing the lubricant onto the (e.g. surface treated) porous layer. The lubricant can also be applied by depositing a solution with the lubricant and one or more volatile liquids (e.g., via any of the previously described methods) and evaporating away the one or more volatile liquids. With any of these methods, the excess lubricant may be mechanically removed (e.g., pushed off the surface with a solid object), absorbed off of the surface using another porous material, removed via gravity or centrifugal forces or removed by utilizing a wash liquid (e.g., water or aqueous liquid medium) to remove excess lubricant.

The lubricant is generally a liquid at the use temperature of the coated substrate. Although environmental use temperatures can range from −40° C. to 45° C., use temperatures most commonly range from 40° F. to 120° F. In typical embodiments, the lubricant is a liquid at room temperature (e.g. 25° C.). In typically embodiments, a single lubricant is utilized. However, a mixture of lubricant can also be used, especially mixtures within the same chemical class.

By “liquid” it is meant that the lubricant has a dynamic (shear) viscosity of at least about 0.1, 0.5, or 1 mPas and no greater than 10⁷ mPas at the use temperature. In typical embodiments, the dynamic viscosity is no greater than 10⁶, 10⁵, 10⁴, or 10³ mPas. The dynamic viscosity values described herein refer to those measured at a shear rate of 1 sec⁻¹.

The lubricant generally has no solubility or only trace solubility with water or other fluid the lubricant is intended to repel, e.g., a solubility of 0.01 g/l or 0.001 g/l or less.

In some embodiments, the surface tension at the boundary of the lubricant is preferably ≦50 mN/m, in particular is in the range from 5 to 45 mN/m, and specifically is in the range from 10 to 40 mN/m at 20° C., in particular when the liquid that is being repelled from the surface is an aqueous liquid.

In some embodiments, the lubricant is a hydrocarbon fluid. Suitable lubricants include low-molecular-weight hydrocarbons such as saturated hydrocarbons having at least 8 carbon atoms, preferably at least 10 carbon atoms, in particular from 10 to about 20 carbon atoms, e.g. octanes, nonanes, decanes, decalin, undecanes, dodecanes, tetradecanes, and hexadecane.

In some embodiments, the lubricant is a branched C₃-C₅₀ hydrocarbon, such as polyisobutenes. Depending on the molecular weight and branching, such materials may be liquids, high-viscosity liquids, or solids.

The hydrocarbon lubricant can optionally comprises substituents such as in the case of alkanols and diols having at least 8 carbon atoms, preferably at least 10 carbon atoms, e.g. 3-octanol, 1-decanol, 2-decanol, undecanols, dodecanols, tridecanols, 2-hexadecanol, 2-hexyldecanol, and 2-octyl-1-dodecanol.

In some embodiments, the lubricant is a fluorinated fluid such as perfluorohydrocarbons (also referred to a perfluoroalkanes), polyfluoroethers, and polyfluroropolyethers. Perfluorohydrocarbons typically have at least 8 carbon atoms, preferably at least 10 carbon atoms, in particular from 10 to 40 carbon atoms, e.g. perfluorodecalins, perfluoroeicosanes, and perfluorotetracosanes. Suitable perfluoropolyethers are available from DuPont as the trade designation KRYTOX. Other suitable perfluoropolyethers are available from Sigma-Aldrich, ranging in molecular weight from about 1500 to about 3500 amu, such as available under the trade designation FOMBLIN Y.

Other suitable lubricants include silicone fluids. The silicones are generally linear, branched, or cyclic polydimethylsiloxanes, or polymethylhydrosiloxanes. These may have various organic end-groups or side-chains. Silicones lubricants are commercially available from Rhodia, Gelest, and Fischer Scientific.

The method of making an article as described herein generally comprises providing a substrate, forming a surface treated porous layer on a surface of the substrate, wherein the porous layer comprises sintered inorganic oxide (e.g. silica) particles and impregnating a lubricant into pores of the surface treated porous layer. The method of forming the surface treated porous layer typically comprises coating a plurality of inorganic oxide particles dispersed in a liquid medium a surface of the substrate. Such coating is also referred to herein as a sol. The sintering of the inorganic oxide nanoparticles can occur during drying of the sol when the sol contains a strong acid or base or the inorganic oxide particles can be thermally sintered, as previously described. After sintering, the porous layer contains a plurality of sintered particles arranged to form a (e.g. continuous) three-dimensional network.

The hydrophobic compound can also be dispersed in a liquid medium (e.g. aqueous and/or organic solvent) and applied to the porous layer as a coating composition. The hydrophobic coating composition can be applied to the porous layer using any suitable application method. The application method often involves forming a coating layer by dip coating, spin coating, spray coating, wiping, roll coating, brushing, spreading, flow coating, or the like, or combinations thereof. Alternatively the hydrophobic compound can be applied to the porous layer via vapor deposition.

The hydrophobic coating composition is typically applied to the porous layer at room temperature (typically in a range of 15° C. to 30° C. or in a range of 20° C. to 25° C.). Alternatively, the porous layer can be preheated at an elevated temperature such as, for example, in a range of 40° C. to 200° C., in a range of 50° C. to 175° C., or in a range of 60° C. to 150° C. before application of the hydrophobic coating composition. The resulting coating can be dried and then cured at ambient temperature (for example, in the range of 15° C. to 30° C. or in the range of 20° C. to 25° C.) or at an elevated temperature (for example, in the range of 40° C. to 200° C., in the range of 50° C. to 175° C., or in the range of 50° C. to 100° C.) for a time sufficient for the curing to take place.

Typically, the hydrophobic layer coating is applied to the porous layer on the substrate such that after curing, a hydrophobic layer is formed over the porous layer. That is, the porous layer is positioned between the substrate and the hydrophobic layer. The hydrophobic layer can be a monolayer or greater than a monolayer in thickness. When greater than a monolayer in thickness, the hydrophobic layer is typically a small fraction of the total thickness and may generally range from a few nanometers to 50, 75 or 100 nm.

In some embodiments, the method further comprises bonding the hydrophobic compound to the porous layer by reacting a surface of the sintered (e.g. silica) particles in the porous layer with a silane compound. The silane compound contains both a reactive silyl group and a hydrophobic group.

After application to the porous layer, the hydrophobic coating composition can be dried and cured by exposure to heat and/or moisture. Curing attaches the silane compound to the porous layer. Curing results in the formation of the —Si—O—Si— bond between the silane compound and the sintered (e.g. silica) particles in the porous layer. The resulting hydrophobic layer is attached to the substrate through the porous layer.

If a crosslinker is included in the coating composition, these materials can react with any remaining reactive silyl groups on the silane compound. Moisture cure can be affected at temperatures ranging from room temperature (for example, 20° C. to 25° C.) up to about 80° C. or more. Moisture curing times can range from a few minutes (for example, at the higher temperatures such as 80° C. or higher) to hours (for example, at the lower temperatures such as at or near room temperature).

For the attachment of the silane compound to the porous layer, sufficient water typically can be present to cause hydrolysis of the hydrolyzable groups described above, so that condensation to form —Si—O—Si— groups can occur (and thereby curing can be achieved). The water can be, for example, present in the hydrocarbon layer coating composition, adsorbed on the substrate surface, or in the ambient atmosphere. Typically, sufficient water can be present if the coating method is carried out at room temperature in an atmosphere containing water (for example, an atmosphere having a relative humidity of about 30 percent to about 50 percent). The silane compound can undergo chemical reaction with the surface of the acid-sintered (e.g. silica) particles in the porous layer to form a hydrophobic hydrocarbon layer through the

The porous layer can be provided on a wide variety of organic or inorganic substrates. The substrate can have a surface that is polymeric material, glass or ceramic material, metal, composite material (e.g., polymer material with inorganic materials), and the like. The substrates can be sheets, films, molded shapes, or other types of surfaces. Suitable substrates can be flexible or rigid, opaque or transparent, reflective or non-reflective, and of any desired size and shape.

Suitable polymeric materials for substrates include, but are not limited to, polyesters (e.g., polyethylene terephthalate or polybutylene terephthalate), polycarbonates, acrylonitrile butadiene styrene (ABS) copolymers, poly(meth)acrylates (e.g., polymethylmethacrylate, or copolymers of various (meth)acrylates), polystyrenes, polysulfones, polyether sulfones, epoxy polymers (e.g., homopolymers or epoxy addition polymers with polydiamines or polydithiols), polyolefins (e.g., polyethylene and copolymers thereof or polypropylene and copolymers thereof), polyvinyl chlorides, polyurethanes, fluorinated polymers, cellulosic materials, derivatives thereof, and the like. In some embodiments, where increased transmissivity is desired, the polymeric substrate can be transparent. The term “transparent” means transmitting at least 85 percent, at least 90 percent, or at least 95 percent of incident light in the visible spectrum (wavelengths in the range of 400 to 700 nanometers). Transparent substrates may be colored or colorless.

Suitable metals include, for example, pure metals, metal alloys, metal oxides, and other metal compounds. Examples of metals include, but are not limited to, chromium, iron, aluminum, silver, gold, copper, nickel, zinc, cobalt, tin, steel (e.g., stainless steel or carbon steel), brass, oxides thereof, alloys thereof, and mixtures thereof.

The combination of the porous layer together with the hydrophobic layer and impregnated lubricant can be used to impart or enhance (e.g. aqueous) liquid repellency of a variety of substrates. In some embodiments, the no greater than 40%, 35%, 30%, 25%, 20%, 15%, 10%, 5%, or 1% of the repellant surface area comprises (e.g. aqueous) liquid after holding the repellent surface vertically for 5 minutes and visually determining (in the absence of a microscope) the amount of (e.g. aqueous) liquid remaining on the repellant surface.

The term “aqueous” means a liquid medium that contains at least 50, 55, 60, 65, or 70 wt-% of water. The liquid medium may contain a higher amount of water such as at least 75, 80, 85, 90, 95, 96, 97, 98, 99 or 100 wt-% water. The liquid medium may comprise a mixture of water and one or more water-soluble organic cosolvent(s), in amounts such that the aqueous liquid medium forms a single phase. Examples of water-soluble organic cosolvents include for example methanol, ethanol, isopropanol, 2-methoxyethanol, 3-methoxypropanol, 1-methoxy-2-propanol, tetrahydrofuran, and ketone or ester solvents. The amount of organic cosolvent does not exceed 50 wt-% of the total liquids of the coating composition. In some embodiments, the amount or organic cosolvent does not exceed 45, 40, 35, 30, 25, 20, 15, 10 or 5 wt-% organic cosolvent. Thus, the term aqueous includes (e.g. distilled) water as well as water-based solutions and dispersions.

The combination of the porous layer, the hydrophobic layer, and impregnated lubricant can render the coated surface hydrophobic. The terms “hydrophobic” refers to a surface on which drops of water or aqueous liquid exhibit an advancing water contact angle of at least 50 degrees, at least 60 degrees, at least 70 degrees, at least 90 degrees, or at least 100 degrees.

In some embodiments, the advancing and/or receding contact angle with water may increase by at least 10, 15, 20, 25, 30, 35, 40 degrees. In some embodiments, the receding contact angle with water may increase by at least 45, 50, 55, 60, or 65 degrees. In some embodiments, surface treatment and impregnated lubricant provides a surface that exhibits an advancing and/or receding contact angle with water of at least 100, 105, 110, or 115 degrees. Favorably the difference between the advancing and receding contact angle with water of the surface treated hydrophobic oil impregnated porous surface is no greater than 10, 9, 8, 7, 6, 5, 4, 3, 2, or 1 degree. As the difference between the advancing and receding contact angle with water increases, the tilt angle needed to slide or roll off a (e.g. water) droplet from a planar surface increases.

Unless specified otherwise, the following definitions are applicable to the presently described invention.

The recitation of any numerical range by endpoints is meant to include the endpoints of the range, all numbers within the range, and any narrower range within the stated range.

The term “a”, “an”, and “the” are used interchangeably with “at least one” to mean one or more of the elements being described.

The term “and/or” means either or both. For example, the expression “A and/or B” means A, B, or a combination of A and B.

The term “alkyl” refers to a monovalent group that is a radical of an alkane and includes groups that are linear, branched, cyclic, bicyclic, or a combination thereof. The alkyl group typically has 1 to 30 carbon atoms. In some embodiments, the alkyl group contains 1 to 20 carbon atoms, 1 to 10 carbon atoms, 1 to 6 carbon atoms, 1 to 4 carbon atoms, or 1 to 3 carbon atoms.

The term “alkylene” refers to a divalent group that is a radical of an alkane and includes groups that are linear, branched, cyclic, bicyclic, or a combination thereof. The alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms.

The term “alkoxy” refers to refers to a monovalent group having an oxy group bonded directly to an alkyl group.

The term “aryl” refers to a monovalent group that is aromatic and carbocyclic. The aryl has at least one aromatic ring and can have one or more additional carbocyclic rings that are fused to the aromatic ring. Any additional rings can be unsaturated, partially saturated, or saturated. Aryl groups often have 6 to 20 carbon atoms, 6 to 18 carbon atoms, 6 to 16 carbon atoms, 6 to 12 carbon atoms, or 6 to 10 carbon atoms.

The term “arylene” refers to a divalent group that is aromatic and carbocyclic. The arylene has at least one aromatic ring and can have one or more additional carbocyclic rings that are fused to the aromatic ring. Any additional rings can be unsaturated, partially saturated, or saturated. Arylene groups often have 6 to 20 carbon atoms, 6 to 18 carbon atoms, 6 to 16 carbon atoms, 6 to 12 carbon atoms, or 6 to 10 carbon atoms.

The term “hydrolyzable group” refers to a group that can react with water having a pH of 1 to 10 under conditions of atmospheric pressure. The hydrolyzable group is often converted to a hydroxyl group when it reacts. The hydroxyl group often undergoes further reactions. Typical hydrolyzable groups include, but are not limited to, alkoxy, aryloxy, aralkyloxy, acyloxy, or halo. As used herein, the term is often used in reference to one of more groups bonded to a silicon atom in a silyl group.

The term “aryloxy” refers to a monovalent group having an oxy group bonded directly to an aryl group.

The term “aralkyloxy” refers to a monovalent group having an oxy group bonded directly to an aralkyl group. Equivalently, it can be considered to be an alkoxy group substituted with an aryl group.

The term “acyloxy” refers to a monovalent group of formula —O(CO)R^{b} where R^{b} is alkyl, aryl, or aralkyl. Suitable alkyl R^{b} groups often have 1 to 10 carbon atoms, 1 to 6 carbon atoms, or 1 to 4 carbon atoms. Suitable aryl R^{b} groups often have 6 to 12 carbon atoms such as, for example, phenyl. Suitable aralkyl R^{b} groups often have an alkyl group with 1 to 10 carbon atoms, 1 to 6 carbon atoms, or 1 to 4 carbon atoms that is substituted with an aryl having 6 to 12 carbon atoms such as, for example, phenyl.

The term “halo” refers to a halogen atom such as fluoro, bromo, iodo, or chloro. When part of a reactive silyl, the halo group is often chloro.

The term “silyl” refers to a monovalent group of formula —Si(R^{c})₃ where R^{c} is hydroxyl, a hydrolyzable group, or a non-hydrolyzable group. In many embodiments, the silyl group is a “reactive silyl” group, which means that the silyl group contains at least one R^{c} group that is a hydroxyl group or hydrolyzable group. Some reactive silyl groups are of formula —Si(R²)₃₋ₓ(R³)ₓ where each group R² is independently hydroxyl or a hydrolyzable group and each group R³ is independently a non-hydrolyzable group. The variable x is an integer equal to 0, 1, or 2.

The term “non-hydrolyzable group” refers to a group that cannot react with water having a pH of 1 to 10 under conditions of atmospheric pressure. Typical non-hydrolyzable groups include, but are not limited to alkyl, aryl, and aralkyl. As used herein, the term is often used in reference to one of more groups bonded to a silicon atom in a silyl group.

The term “fluorinated” refers to a group or compound that contains at least one fluorine atom attached to a carbon atom. Perfluorinated groups, in which there are no carbon-hydrogen bonds, are a subset of fluorinated groups.

The term “perfluorinated group” refers to a group having all C—H bonds replaced with C—F bonds. Examples include monovalent or divalent radicals of a perfluoropolyether, perfluoroether, or perfluoroalkane.

The term “perfluoroether” refers to ether in which all of the C—H bonds are replaced with C—F bonds. It refers to a group or compound having two perfluorinated groups (e.g., a perfluoroalkylene and/or perfluoroalkyl) linked with an oxygen atom. That is, there is a single catemated oxygen atom. The perfluorinated groups can be saturated or unsaturated and can be linear, branched, cyclic, or a combination thereof.

The term “perfluoropolyether” refers to a polyether in which all of the C—H bonds are replaced with C—F bonds. It refers to a group or compound having three or more perfluorinated groups (e.g., a perfluoroalkylene and/or perfluoroalkyl) linked with oxygen atoms. That is, there are two or more catemated oxygen atoms. The perfluorinated groups can be saturated or unsaturated and can be linear, branched, cyclic, or a combination thereof.

The term “perfluoroalkyl” refers to an alkyl with all the hydrogen atoms replaced with fluorine atoms. Stated differently, all of the C—H bonds are replaced with C—F bonds.

The term “perfluoroalkane” refers to an alkane with all the C—H bonds replaced with C—F bonds.

The term “agglomerate” refers to a weak association between primary particles which may be held together by charge or polarity and can be broken down into smaller entities.

The term “primary particle size” refers to the mean diameter of a single (non-aggregate, non-agglomerate) particle.

The term “aggregate” with respect to particles refers to strongly bonded or fused particles where the resulting external surface area may be significantly smaller than the sum of calculated surface areas of the individual components. The forces holding an aggregate together are strong forces, for example covalent bonds, or those resulting from sintering or complex physical entanglement. Thus aggregates cannot be broken down into smaller entities such as discrete primary particles.

### EXAMPLES

Objects and advantages of this invention are further illustrated by the following examples, but the particular materials and amounts thereof recited in these examples, as well as other conditions and details, should not be construed to unduly limit this invention. These examples are for illustrative purposes only and are not meant to be limiting on the scope of the appended claims.

### Materials:

| Material | | |
|---|---|---|
| designation | Description | Obtained from |
| NALCO 1115 | Silica sol, particle size of 4 nm and 16.2 | Nalco Company, |
| | wt % solids | Naperville, IL under trade |
| | | designation “NALCO 1115” |
| NALCO 2329 | Silica sol, particle size of 75 nm and | Nalco Company, |
| | 40.5 wt % | Naperville, IL under trade |
| | | designation “NALCO 2329” |
| NALCO 1056 | Alumina-Coated-Silica sol, particle size | Nalco Company, |
| | of 20 nm, 4 wt % Al₂O₃ and 26 wt % | Naperville, IL under trade |
| | SiO₂ | designation “NALCO 1056” |
| NALCO 8676 | Alumina sol, particle size of 2 nm and | Nalco Company, |
| | 10 wt % solids | Naperville, IL under trade |
| | | designation “NALCO 8676” |
| SNOWTEX | Silica sol, elongated silica particles, | Nissan Chemical America |
| UP | particle size of 9-15 nm × 40-100 nm, | Corp., Houston TX under |
| | 21.3 wt % | trade designation |
| | | “SNOWTEX UP” |
| CAB-O- | An aqueous dispersion of CAB-O-SIL ® | Cabot Corp., Billerica, MA |
| SPERSE | M-5 fumed silica | under trade designation |
| 2020K | | “CAB-O-SPERSE 2020K” |
| AEROSIL | Fumed silica powder with a specific | Evonik Industries, |
| 200 | surface area of 200 m²/g, | Piscataway, NJ under trade |
| | aggregate particle size 0.2-0.3 microns | designation “AEROSIL |
| | (with 90 seconds of sonication) | 200” |
| MEK | Methyl ethyl ketone | Avantor Performance |
| | | Materials, Center Valley, |
| | | PA under the trade |
| | | designation “JT Baker” |
| IPA solvent | Isopropanol | BDH Chemicals/WWR, |
| | | Radnor, PA |
| 2-amino-1,3- | H₂NCH—(CH₂OH)₂ | TCI America, Portand, OR |
| propane diol | | |
| HFE 7100 | methoxy-nonafluorobutane, (C₄F₉OCH₃), | 3M Company, St. Paul, MN |
| solvent | is a clear, colorless and | under trade designation “3M |
| | low-odor fluid | NOVEC 7100 ENGINEERED |
| | | FLUID” |
| HFPO Silane | a compound of formula | Synthesized using technique |
| Hydrophobic | F(CF(CF₃)CF₂O)ₐCF(CF₃)— | described below |
| Surface | CONH(CH₂)₃Si(OCH₃)₃ where the | |
| Treatment | variable a is in the range of 4 to 20 | |
| Compound | | |
| Alpha-Omega | a compound of formula | Synthesized using technique |
| HFPO Silane | (CH₃O)₃Si(CH₂)₃NHC(O)O | described below |
| Hydrophobic | CH₂CH₂NHC(O)CF(CF₃)CF₂O(CF(CF | |
| Surface | ₃)CF₂O)_{b}CF(CF₃)— | |
| Treatment | C(O)NHCH₂CH2OC(O) | |
| Compound | NH(CH₂)₃Si(OCH₃)₃ where the variable | |
| | a is in the range of 5 to 19 | |
| Dipodal | a compound of formula | Synthesized using technique |
| HFPO Silane | F(CF(CF₃)CF₂O)ₐCF(CF₃)— | described below |
| Hydrophobic | CONHCH[CH₂OC(O)NH(CH₂)₃Si(OC | |
| Surface | H₃)₃]₂ where the variable a is in the | |
| Treatment | range of 4 to 20 | |
| Compound | | |
| Hydrocarbon | 13(chlorodimethylsilylmethyl) | Gelest Inc. |
| silane | heptanosane | Morrisville, PA |
| Hydrocarbon | triacontyldimethylchlorosilane | Gelest Inc. |
| silane | | Morrisville, PA |
| Hydrocarbon | Trimethoxy(octadecyl)silane | Sigma-Aldrich Chemical |
| trimethoxy | | Company., St. Louis, MO |
| silane | | |
| THV 221 | a fluoroplastic composed of | 3M Company, St. Paul, MN |
| | tetrafluoroethylene, | under trade designation “3M |
| | hexafluoropropylene, and vinylidene | THV 221AZ” |
| | fluoride | |
| S159-500 | Silicone oil, poly(dimethylsiloxane), | Fisher Scientific, Pittsburg, |
| Lubricant | 500 mPa | PA |
| FOMBLIN Y | Perfluoropolyether | Sigma-Aldrich Chemical |
| 14/6 | | Company., St. Louis, MO |
| Lubricant | | |
| FOMBLIN Y | Perfluoropolyether | Sigma-Aldrich Chemical |
| 6/6 | | Company., St. Louis, MO |
| Lubricant | | |
| Lubricant | 2-octyl-1-dodecanol | Sigma-Aldrich Chemical |
| Company | | |
| Lubricant | Mineral Oil | Vi-Jon |
| | | Smyrna, TN |
| PRIPOL 2033 | Dimer diol, C36 branched | Croda, Edison, NJ |
| Lubricant | | |
| GENIOSIL | 3-isocyanatopropyl | Evonik Industries, |
| GF-40 | trimethoxysilane | Piscataway, NJ under trade |
| | | designation “GENIOSIL GF |
| | | 40” |
| DBU | 1,8-diazabicyclo[5.4.0]undec-7-ene | Shanghai Rongrong |
| | | Chemical Co., Ltd., |
| | | Shanghai, China |
| DBTDL | dibutyltin dilaurate | Sigma-Aldrich Chemical |
| | | Company |
| HNO₃ | Nitric acid | EMD Millipore, Billerica, |
| NH₄OH | Ammonium hydroxide | MA |
| MgSO₄ | Anhydrous magnesium sulfate | |
| DS-10 | sodium dodecylbenzenesulfonate | Sigma-Aldrich Chemical |
| SURFACTANT | Company | |
| Solvent | Ethyl acetate, methyl-t-butyl ether | WWR, Radnor, PA |
| PET Film | 2 mil (51 micrometers) polyethylene | 3M Company, St. Paul, MN |
| | terephthalate film | |
| Glass slides | 1.5 inches × 3 inches (3.8 cm × 7.62 cm) | Fisher Scientific, Pittsburg, |
| | | PA |

### Methods

IR data was obtained using a Nicolet 6700 Series FT-IR spectrometer (Thermo Scientific, Waltham, Mass.).

### Method for Water Contact Angle Measurements

Water contact angles were measured using a Ram6-Hart goniometer (Ram6-Hart Instrument Co., Succasunna, N.J.). Advancing (θ_{adv}) and receding (θ_{rec}) angles were measured as water was supplied via a syringe into or out of sessile droplets (drop volume ˜5 μL). Measurements were taken at 2 different spots on each surface, and the reported measurements are the averages of the four values for each sample (a left-side and right-side measurement for each drop).

### Synthesis of Hexafluoropropyleneoxide (HFPO) Silane

HFPO silane is a compound of formula F(CF(CF₃)CF₂O)ₐCF(CF₃)—CONH(CH₂)₃Si(OCH₃)₃ where the variable a is in the range of 4 to 20. This material was prepared by charging HFPO—COOCH₃ (20 grams, 0.01579 mole) and NH₂CH₂CH₂CH₂—Si(OCH₃)₃ (2.82 grams, 0.01579 mole) under a N₂ atmosphere into a 100 mL 3-necked, round bottom flask equipped with a magnetic stir bar, nitrogen (N₂) inlet, and reflux condenser. The reaction mixture was heated at 75° C. for 12 hours. The reaction was monitored by infrared (IR) spectroscopy; after the disappearance of the ester peak, the resulting clear, viscous oil was kept under vacuum for another 8 hours and used as such.

### Synthesis of Alpha-Omega Hexafluoropropyleneoxide (HFPO) Silane

The alpha omega HFPO dimethyl ester CH₃OC(O)—HFPO—C(O)OCH₃ was prepared by a method similar to Preparation No. 26 of U.S. Pat. No. 7,718,264

The starting diol HOCH₂CH₂NHC(O)—HFPO—C(O)NHCH₂CH₂OH was prepared using 100 g (0.0704 mol, 0.1408 eq, 1420 MW) of divalent alpha omega HFPO dimethyl ester (CH₃OC(O)—HFPO—C(O)OCH₃) described above and 11.18 g (0.1831 mole) ethanolamine by a procedure similar to the Preparation No. 27 of U.S. Pat. No. 7,718,264.

A 30 mL jar equipped with stirbar was charged with 10 g (0.006766 mol, 0.13532 eq, 1478 MW) HOCH₂CH₂NHC(O)—HFPO—C(O)NHCH₂CH₂OH was and 2.78 g (0.013532 eq) Geniosil GF-40, and 75 microliters of a 10% solution of DBTDL in MEK, was sealed and placed in a 75° C. bath with magnetic stirring, and heated for 2 h. At the end of 2 h, FTIR analysis of the reaction showed no residual —NCO peak at about 2265 cm⁻¹ to provide the product (CH₃O)₃Si(CH₂)₃NHC(O)OCH₂CH₂NHC(O)—HFPO—C(O)NHCH₂CH₂OC(O) NH(CH₂)₃Si(OCH₃)₃.

### Synthesis of Dipodal Hexafluoropropyleneoxide (HFPO) Silane

The starting was diol HFPO—CONHCH[CH₂OH]₂ prepared by charging a 500 mL roundbottom equipped with stirbar with 100 g (0.0735 mol, 1420 nominal MW) HFPO—C(O)OCH₃ and 8.34 g (0.0915 mol) 2-amino-1,3-propane diol and heating for 2 h at 75° C. To the reaction was added 200 g of methyl-t-butyl ether, and a yellow oil (likely unreacted 2-amino-1,3-propane diol) separated from the reaction. The reaction was then poured into a separatory funnel, not adding the yellow oil, The reaction was washed with 20 mL of 2N aqueous HCl and allowed to separate overnight. The organic layer was washed with 20 mL 1N ammonium hydroxide, allowed to separate for 30 min, washed with 20 mL water, and allowed to separate for 30 min, then dried over anhydrous magnesium sulfate, filtered and concentrated at up to 95° C. for ˜1.5 h to provide the diol HFPO—CONHCH[CH₂OH]₂.

A 30 mL jar equipped with stirbar was charged with 12.79 g HFPO—CONHCH[CH₂OH]₂ and 2.78 g (0.013532 eq) Geniosil GF-40, and 75 microliters of a 10% solution of DBTDL in MEK, was sealed and placed in a 75° C. bath with magnetic stirring, and heated for about 24 h. At the end of 2 h, FTIR analysis of the reaction showed no residual —NCO peak at about 2265 cm⁻¹ to provide the product HFPO—CONHCH[CH₂OC(O)NH(CH₂)₃Si(OCH₃)₃]₂

### Synthesis of Dimer Diol Silane

A 25 mL jar equipped with a stirbar was charged with 10 g (570 MW, 285 MW, 0.0351 eq) Pripol 2033, 7.20 g (205.29, 0.0351 eq) Geniosil GF-40, and 100 microliters of a 10% solution of DBTDL in MEK, was sealed and placed in a 75° C. bath with magnetic stirring, and heated for 2 h. At the end of 2 h, FTIR analysis of the reaction showed no residual —NCO peak at about 2265 cm⁻¹.

### Preparative Examples 1-13 (PE1-PE13)

PE1 coating formulation was prepared by first diluting a dispersion of NALCO 1115 to a solids content of 5 wt. % by adding appropriate amount of distilled (DI) water. Then, 1M HNO₃ catalyst was added to the diluted dispersion to adjust the pH of the dispersion to 2.

PE2-PE16 coating formulations were prepared in the same manner as PE1 except that the silica, silica/alumina, or alumina dispersion was varied. PE6-PE8 coating formulations containing AEROSIL 200 were prepared by adding AEROSIL 200 to a diluted dispersion of NALCO 1115 at the desired ratio and adjusting the solids content to 5 wt. %.

PE17 and PE18 were prepared in the same manner as PE1 except that the silica dispersion was varied and DBU catalyst was added to the silica dispersion instead of HNO₃ catalyst to adjust the pH of the dispersion to 12. PE10 and PE11 coating formulations further contained a 0.05 wt. % of a DS-10 surfactant.

PE19 and PE20 coating formulations were prepared in the same manner as PE18 and PE-19, respectively, except that no DBU or HNO₃ was added to the formulation.

PE21 coating formulation was prepared by adding AEROSIL 200 powder to distilled water under the solids content reached 5 wt %. This formulation further contained a 0.05 wt. % of a DS-10 surfactant.

PE22 coating formulation was prepared by first diluting a dispersion of NALCO 8676 to a solids content of 5 wt. % by adding appropriate amount of distilled (DI) water. Then, DS-10 surfactant was added until the formulation contained a 0.05 wt. % DS-10 surfactant.

Table 1, below, summarizes the coating formulations for PE1-PE23.

TABLE 1

| | | | | Amount |
|---|---|---|---|---|
| | | | | of DS-10 |
| | | | | added |
| Example | Porous Coating Formulation | Catalyst | pH | (wt. %) |
| PE1 | NALCO 1115 | HNO₃ | 2 | — |
| PE2 | 70% NALCO 1115 + 30% NALCO 2329 | HNO₃ | 2 | — |
| PE3 | 30% o NALCO 1115 + 70% NALCO | HNO₃ | 2 | — |
| | 2329 | | | |
| PE4 | 70% NALCO 1115 + 30% SNOWTEX | HNO₃ | 2 | — |
| | UP | | | |
| PE5 | 30% NALCO 1115 + 70% SNOWTEX | HNO₃ | 2 | — |
| | UP | | | |
| PE6 | 70% NALCO 1115 + 30% AEROSIL 200 | HNO₃ | 2 | — |
| PE7 | 30% NALCO 1115 + 70% AEROSIL200 | HNO₃ | 2 | — |
| PE8 | 2% NALCO 1115 + 98% AEROSIL 200 | HNO₃ | 2 | — |
| PE9 | 70% NALCO 1115 + 30% CAB-O- | HNO₃ | 2 | — |
| | SPERSE 2020K | | | |
| PE10 | 30% NALCO 1115 + 70% CAB-O- | HNO₃ | 2 | — |
| | SPERSE 2020K | | | |
| PE11 | 10% NALCO 1056 + 90% NALCO 1115 | HNO₃ | 2 | — |
| PE12 | 50% NALCO 1056 + 50% NALCO 1115 | HNO₃ | 2 | — |
| PE13 | 90% NALCO 1056 + 10% NALCO 1115 | HNO₃ | 2 | — |
| PE14 | 10% NALCO 8676 + 90% NALCO 1115 | HNO₃ | 2 | — |
| PE15 | 50% NALCO 8676 + 50% NALCO 1115 | HNO₃ | 2 | — |
| PE16 | 90% NALCO 8676 + 10% NALCO 1115 | HNO₃ | 2 | — |
| PE17 | 30% NALCO 1115 + 70% NALCO 2329 | DBU | 12 | 0.05 |
| PE18 | 70% NALCO 1115 + 30% AEROSIL 200 | DBU | 12 | 0.05 |
| PE19 | 30% NALCO 1115 + 70% NALCO 2329 | — | 10 | 0.05 |
| PE20 | 70% NALCO 1115 + 30% AEROSIL 200 | — | 10 | 0.05 |
| PE21 | AEROSIL 200 | — | 5 | 0.05 |
| PE22 | NALCO 8676 | — | 5 | 0.05 |

The PE1-PE23 coating formulations were then coated on PET films (PE1-PE19) or glass slides (PE20-23) using a Mayer Rod #4 (PE1-PE16, PE18-PE23) or Mayer Rod #25 (PE17), corresponding to a wet thickness of approximately 9.1 micrometers or 57.1 micrometers, respectively.

All of the samples coated on PET films were allowed to air dry for 3-10 minutes and were then placed in a 150° C. oven for 10 minutes to sinter the particles. Since the coated substrates had a tendency to curl during thermal annealing, microscope slides were placed on top of the edges of the coated substrates to prevent them from curling.

The coated glass microscope slides were allowed to air dry for 3-10 minutes, placed in a 550° C. furnace for 1 hour to thermally sinter the particles, and then cooled to room temperature.

The coated PE1-PE23 samples with a porous layer were then subjected to a surface modification treatment. In some embodiments, various reactive species were used to form a hydrophobic layer as follows: to treat with HFPO Silane, a 0.5 wt. % solution of HFPO Silane in HFE 7100 (98 wt % and IPA (1.5 wt. %) was dropped on the coated PE1-PE23 sample and the sample was left overnight to evaporate the solvents.

To treat the coated PE3 sample with HMDS, the coated sample was placed on a sealed vacuum desiccator alongside a vial containing 5 mL of HMDS and allowed to sit over night.

To treat the coated PE3 or PE7 sample with 13-(chlorodimethylsilylmethyl) heptanosane, triacontyldimethylchlorosilane, or Dimer Diol Silane, a solution comprising 1 wt. % of the desired silane, 9 wt. % deionized water, and 90 wt. % isopropanol was allowed to stir overnight. The coated PE3 or PE7 sample was dipped into this solution and allowed to dry overnight.

To treat the coated PE3 with trimethoxy(octadecyl)silane, dipodal HFPO silane, or alpha-omega HFPO silane, a solution of 2 wt % of the desired silane in 98% IPA:H₂O (95:5 v/v) was allowed to stir overnight. The coated PE3 sample was dipped into this solution and allowed to dry overnight.

To treat with THV221, a 0.1 wt % solution of THV221 in MEK was dropped on the coated PE7 sample and the sample was left overnight to evaporate the solvents.

### Examples 24-66 (EX24-EX66) and Comparative Examples A-E (CE.A-CE.E)

EX24-EX66 samples were prepared by impregnating various lubricants into surface treated porous PE1-PE23 samples described above. This was accomplished by dropping the desired lubricant onto the PE1-PE23 samples and allowing the lubricant to spread until the entire surface treated porous layer was coated followed by holding the samples vertically overnight to drain off excess lubricant.

Table 2, below summarizes the coating formulations, hydrophobic surface treatments, and lubricants as well as the measured water contact angles.

TABLE 2

| | Porous | Hydrophobic | | Water Contact | |
|---|---|---|---|---|---|
| | Coating | Surface | | Angle (degrees) | |
| Example | Formulation | Treatment | Lubricant | θadv | θrec |
| CE.A | none | none | none | 77 | 52 |
| CE.B | PE5 | none | none | <10 | <10 |
| CE.C | none | none | Fomblin Y 14/6 | 75 | 61 |
| CE.D | PE5 | none | Fomblin Y 14/6 | 25 | <10 |
| CE.E | PE5 | HFPO Silane | none | 123 | 76 |
| EX24 | PE1 | HFPO Silane | Fomblin Y 14/6 | 107 | 103 |
| EX25 | PE2 | HFPO Silane | Fomblin Y 14/6 | 108 | 100 |
| EX26 | PE3 | HFPO Silane | Fomblin Y 14/6 | 110 | 105 |
| EX27 | PE4 | HFPO Silane | Fomblin Y 14/6 | 107 | 101 |
| EX28 | PES | HFPO Silane | Fomblin Y 14/6 | 108 | 104 |
| EX29 | PE6 | HFPO Silane | Fomblin Y 14/6 | 103 | 98 |
| EX30 | PE7 | HFPO Silane | Fomblin Y 14/6 | 108 | 103 |
| EX31 | PE8 | HFPO Silane | Fomblin Y 14/6 | 97 | 96 |
| EX32 | PE9 | HFPO Silane | Fomblin Y 14/6 | 105 | 99 |
| EX33 | PE10 | HFPO Silane | Fomblin Y 14/6 | 105 | 101 |
| EX34 | PE11 | HFPO Silane | Fomblin Y 14/6 | 95 | 93 |
| EX35 | PE12 | HFPO Silane | Fomblin Y 14/6 | 92 | 89 |
| EX36 | PE13 | HFPO Silane | Fomblin Y 14/6 | 96 | 94 |
| EX37 | PE14 | HFPO Silane | Fomblin Y 14/6 | 94 | 91 |
| EX38 | PE15 | HFPO Silane | Fomblin Y 14/6 | 100 | 98 |
| EX39 | PE16 | HFPO Silane | Fomblin Y 14/6 | 99 | 93 |
| EX40 | PE17 | HFPO Silane | Fomblin Y 14/6 | 115 | 114 |
| EX41 | PE 18 | HFPO Silane | Fomblin Y 14/6 | 110 | 104 |
| EX42 | PE19 | HFPO Silane | Fomblin Y 14/6 | 100 | 97 |
| EX43 | PE20 | HFPO Silane | Fomblin Y 14/6 | 102 | 99 |
| EX44 | PE21 | HFPO Silane | Fomblin Y 14/6 | 103 | 99 |
| EX45 | PE22 | HFPO Silane | Fomblin Y 14/6 | 102 | 100 |
| EX46 | PE3 | 13- | 2-octyl-1- | 93 | 88 |
| | | (chlorodimethyl | dodecanol | | |
| | | silylmethyl) | | | |
| | | heptanosane | | | |
| EX47 | PE3 | triacontyldimet | 2-octyl-1- | 90 | 86 |
| | | hylchlorosilane | dodecanol | | |
| EX48 | PE3 | Dimer Diol | Dimer Diol | 59 | 54 |
| | | Silane | | | |
| EX49 | PE 7 | Dimer Diol | Dimer Diol | 57 | 53 |
| | | Silane | | | |
| EX50 | PE3 | HMDS | Silicone Oil | 101 | 99 |
| EX51 | PE7 | THV221 | Fomblin Y 14/6 | 119 | 112 |
| EX52 | PE3 | Trimethoxy | Mineral oil | 93 | 88 |
| | | (octadecyl) | | | |
| | | silane | | | |
| EX53 | PE3 | Dipodal | Fomblin Y 6/6 | 107 | 103 |
| | | HFPO Silane | | | |
| EX54 | PE3 | Alpha-omega | Fomblin Y 6/6 | 106 | 98 |
| | | HFPO silane | | | |

The difference between the advancing and receding contact angle for all of the lubricant-impregnated samples (EX24-EX51) was lower than 10°, consistent with facile movement of contacting water droplets. The Comparative Examples, in contrast, were characterized by water contact angle hysteresis above 10°, indicative of more resistance to drop motion. Note that CE.B was characterized by no difference between the advancing and receding contact angle because contacting water droplets instantly spread on the porous layer. This sheet of water was not easily removed by tilting, however, meaning CE. B was not repellent to water.

1. A method of making an article, the method comprising:
(a) providing a substrate;
(b) forming a surface treated porous layer on a surface of the substrate, wherein the porous layer comprises sintered inorganic oxide particles and a surface of the porous layer comprises a hydrophobic layer; and
(c) impregnating a lubricant into pores of the surface treated porous layer.

2. The method of claim 1 wherein the method of forming the surface treated porous layer comprises
(b1) coating a plurality of inorganic oxide particles dispersed in a liquid medium on a surface of the substrate;
(b2) sintering the inorganic oxide particles forming a porous layer; and
(b3) coating a surface of the porous layer with a hydrophobic material.

3. The method of claim 2 wherein the liquid medium further comprises acid.

4. The method of claim 3 wherein the acid has a pKa of less than 3.5 and the solution has a pH ranging from about 2 to 5.

5. The method of claim 4 wherein the liquid medium is free of surfactant.

6. The method of claim 2 wherein the liquid medium further comprises a base.

7. The method of claim 1 wherein the inorganic oxide particles are nanoparticles sintered at a temperature no greater than 250° C.

8. The method of claim 2 wherein (b3) comprises coating the surface of the porous layer with a coating solution comprising the hydrophobic compound dispersed in a liquid medium.

9. The method of claim 2 wherein (b3) comprises coating the surface of the porous layer via vapor deposition of the hydrophobic compound.

10. The method of claim 1 wherein the substrate is organic, inorganic, or a combination thereof.

11. The method of claim 1 wherein the inorganic oxide particles are fixed to the substrate in the absence of an organic polymeric binder.

12. The method of claim 1 wherein the porous three-dimensional network of sintered inorganic oxide particles has an inorganic content of at least 90 wt-%.

13. The method of claim 1 wherein the sintered inorganic oxide particles comprise silica, alumina, or a mixture thereof.

14-17. (canceled)

18. The method of claim 1 wherein the hydrophobic layer is covalently bonded to the porous layer.

19. The method of claim 18 wherein the hydrophobic layer comprises a compound having the general formula A-B or A-B-A, wherein A is a reactive silyl group capable of bonding with the sintered inorganic oxide particles and B is a hydrophobic group.

20-25. (canceled)

26. The method of claim 1 wherein the hydrophobic layer comprises a hydrophobic group of the same chemical class as the lubricant.

27. The method of claim 26 wherein the hydrophobic layer comprises a fluorinated group and the lubricant is a fluorinated liquid.

28. The method of claim 26 wherein the hydrophobic layer comprises a hydrocarbon group, a silane group, or a combination thereof and the lubricant is a hydrocarbon liquid or silicone liquid.

29. The method of claim 1 wherein the substrate comprises an organic polymeric material.

30. (canceled)

31. An article comprising:
(a) a substrate;
(b) a surface treated porous layer disposed on a surface of the substrate, the surface treated porous layer comprising
a plurality of sintered inorganic oxide particles arranged to form a porous three-dimensional network;
a hydrophobic layer disposed on a surface of the porous three-dimensional network, and
(c) a lubricant impregnated in pores of the surface treated porous layer.

32. (canceled)
